(19) United States
(12) Patent Application Publication
(10) Pub. No.: US 2025/0383283 A1
(43) Pub. Date: Dec. 18, 2025

(54) METHOD FOR EVALUATING UV PROTECTION PERFORMANCE OF COSMETIC

(71) Applicants: KURODA CONSULTING INCORPORATED, Yokohama-shi (JP); KEIO UNIVERSITY, Tokyo (JP)

(72) Inventors: Akihiro KURODA, Yokohama-shi (JP); Kouichi ASAKURA, Yokohama-shi (JP)

(21) Appl. No.: 19/086,697

(22) Filed: Mar. 21, 2025

(30) Foreign Application Priority Data
Jun. 13, 2024 (JP) 2024-096211

(51) Int. Cl. G01N 21/33; G01N 1/28; G01N 17/00

(52) U.S. Cl. CPC G01N 21/33; G01N 1/2813; G01N 17/004

(57) ABSTRACT

A method for evaluating UV protection performance of a cosmetic includes a preparation step of preparing a measurement sample for evaluating UV protection performance of a target cosmetic, wherein the preparation step is a step including forming a uniform cosmetic application layer of the cosmetic on an UV-transmittance-measurement transparent substrate surface, by using a surface of an applicator having a layer made of a non-metal material constituting the surface that has an oil adhesion prevention property. According to the method, an UV transmission ratio of the cosmetic can easily and accurately be evaluated.

### CROSS-REFERENCE TO RELATED APPLICATIONS

The present application claims priority to Japanese Patent Application No. 2024-096211, filed Jun. 13, 2024, the disclosure of which is incorporated herein by reference in its entirety including any and all particular combinations of the features disclosed therein.

### BACKGROUND

### Field of the Invention

The present invention relates to a method for evaluating UV protection performance of a cosmetic.

### Description of the Related Art

Hereinafter, the technical background of the present invention will be described.

Currently in Japan, as indicators of the UV protection effect in cosmetics, SPF (an abbreviation of Sun Protection Factor), which indicates a protection ability of UV B rays having a wavelength of 290 to 320 nm, and UVA-PA (Protection grade of UVA), which indicates a protection ability of UV A rays having a wavelength of 320 to 400 nm, are used. In the case where measurement results of these are indicated for cosmetics, measured values or grades thereof are required to be indicated on the basis of the measurement method standards (Non Patent Literature 1 and Non Patent Literature 2) specified by Japan Cosmetic Industry Association.

Also in overseas, the indication is basically required in accordance with measurement methods and indication methods (Non Patent Literature 3) of each region, but basic measurement methods are almost standardized. In the measurement method standards, the back of a human is used, the back is irradiated with high-power UV rays, and the UV protection effect is determined from the results of visual observation of inflammation reaction and darkening reaction that occur on the skin in that case. However, use of humans is time-consuming and costly, and it takes a long time to obtain measurement results.

In addition, since there are ethical and medical issues with the use of humans, in Japan and Europe, measurement methods for measuring the UV protection effect using machines without using humans have been investigated (Non Patent Literature 4). However, it has been reported that there are many problems with the measurement methods currently in progress (Non Patent Literature 5). In studies conducted by the inventors of the present invention, it has been found that even when the test is performed using the same sample within the same standards, the SPF values vary by up to about 20 times.

The use of the method disclosed in Patent Literature 1 can largely solve this problem. However, studies conducted using this method have found that a new problem occurs. This is the phenomenon that use of substrates having different contact angles to water results in a significant change in the measured values of a sample (Non Patent Literature 6).

In view of the above, there is a need to develop measurement methods that can perform highly accurate measurements with as little effort as possible, and highly accurate measurements have been achieved by the inventions of Patent Literatures 2 to 7 centered on Patent Literatures 2 and 3 invented by the inventors of the present invention.

### BACKGROUND ART LITERATURES

### Patent Literature

Patent Literature 1: International Publication No. 2018/047707
Patent Literature 2: Japanese Patent No. 6741261
Patent Literature 3: Japanese Patent No. 6842778
Patent Literature 4: Japanese Patent No. 5825654
Patent Literature 5: Japanese Unexamined Patent Application Publication No. 2021-65873
Patent Literature 6: Japanese Unexamined Patent Application Publication No. 2023-57509
Patent Literature 7: Japanese Unexamined Patent Application Publication No. 2023-95723

### Non-Patent Literature

Non-patent Literature 1: Japan Cosmetic Industry Association, UV protection cosmetics and UV protection effects-SPF and PA indication-2003 revised version
Non-patent Literature 2: Japan Cosmetic Industry Association, Japan Cosmetic Industry Association Standard SPF test method <2007 revised version>
Non-patent Literature 3: ISO/TR26369 Cosmetics—Sun protection test methods—Review and evaluation of methods to assess the photoprotection of sun protection products
Non-patent Literature 4: Colipa Guidelines, Method for in vitro Determination of UVA protection, 2009
Non-patent Literature 5: Rohr, M.; Klette, E.; Ruppert, S.; Bimzcok, R.; Klebon, B.; Heinrich, U.; Tronnier, H.; Johncock, W.; Peters, S.; Pfluecker, F.; Rudolph, T.; Floesser-Mueller, H.; Jenni, K.; Kockott, D.; Lademann, J.; Herzog, B.; Bielfeldt, S.; Mendrok-Edinger, C.; Hanay, C.; Zastrow, L. “in vitro Sun Protection Factor: Still a Challenge with No Final Answer” Skin Pharmacol. Phys. 2010, 23 (4), 201-212.
Non-patent Literature 6: K. Asakura, A. Kuroda, IFSCC Magazine 21 (2), 53-57 (2018).

### SUMMARY

Cosmetics have different physical properties, such as hydrophilicity, lipophilicity, and intermediate properties between hydrophilicity and lipophilicity depending on their composition. When cosmetics are applied to only one type of substrate with a fixed contact angle to water, even if some of the cosmetics can be uniformly applied, the other cosmetics cannot be uniformly applied, and the cosmetics may be subjected to phase separation or may be repelled from a part of the surface of the substrate, resulting in the formation of a non-uniform coating film, for example, with a part on the surface of the substrate exposed.

For this reason, even if the measurement accuracy is improved, the properties can only be grasped by preparing, for measurement, substrates having many different contact angles in advance and plotting the measured values on a graph. Measuring just one product may require a lot of effort, for example, measurements for substrates having a plurality of types of contact angles are necessary.

This process is extremely time-consuming compared with the in vivo method, meaning that it is not a practical alternative method.

Furthermore, when more than 200 commercially available cosmetics from around the world were measured by the methods in the related art, it has been found that some cosmetic products behaved in a different manner from that we expected, and thus we conducted research into the cause of this. According to the results, since the applicator is made of metal, in a cosmetic having a strong affinity for a lipophilic metal, phase separation of the cosmetic occurs at a gap portion of the applicator and a front face portion thereof. Subsequently, a phenomenon occurred in which most of the cosmetic adhered to the applicator side and almost no cosmetic remained on a surface to be coated on the substrate. Furthermore, also in a preparation where such a phenomenon does not occur, an infrared imaging microscope was used to examine a change in the amount of UV absorbent in a coating film which had been confirmed to have a uniform film thickness using a rotary film thickness gauge. Consequently, it was found that when a stainless-steel four-sided applicator was used, regions where the concentration of the UV absorbent increased periodically are present, that is, the concentration of the UV absorbent may become uneven depending on the position of the coating film. This means that accurate measurements cannot be performed by measuring only the film thickness.

Furthermore, when corona-discharge treatment is performed to prepare a superhydrophilic substrate, a corona-discharge treatment device generates strong electromagnetic noise; therefore, the device may not be usable in office buildings or the like. Furthermore, when a cosmetic is applied to a surface of a substrate, the resulting coating film may have a large striped pattern having irregularities. In this case, if a rotary wet film thickness gauge is used to measure the coating film thickness, the measured value and the actual film thickness differ greatly. In addition, the values obtained using the calculation formulas specified in the ISO methods described in Non Patent Literature 4 may differ from the data obtained from human subjects.

An object of the present invention is to provide a method for evaluating a UV transmission ratio of a cosmetic, the method solving the problems described above.

By adopting the configuration described below, an applicator in which a material layer (obtained by, for example, winding a resin film) having an oil adhesion prevention property is formed on the surface of a cylindrical applicator is used instead of an applicator having a surface made of a metal (stainless steel) to particularly suppress excessive adhesion of an oily component of a cosmetic to the applicator.

In addition, a plurality of types of UV transmission ratio evaluation substrates having different contact angles, such as an UV-transmittance-measurement transparent substrate with superhydrophilic properties, obtained by coating, with various materials such as inulin, a surface of a quartz plate or the like that had been subjected to corona discharge in advance were adopted instead of a corona-discharge-treated quartz plate itself. A uniform cosmetic application layer is formed on each of the surfaces of these substrates using one type of cosmetic with an applicator having a surface made of a material having an oil adhesion prevention property. As a result, experimentally, no matter what properties (such as hydrophilicity, lipophilicity, and intermediate properties between hydrophilicity and lipophilicity and properties such as liquid, solid, cream-like, and stick-like) the cosmetic has, a thin layer of the cosmetic can be uniformly formed on at least one of the plurality of types of UV transmission ratio evaluation substrates. By adopting this means, the need to use a corona-discharge device for surface treatment of the substrates at the test site is eliminated. As a result, measurements with higher accuracy can be performed by comparing an absorbance value of a coated cosmetic layer at a specific wavelength measured by a spectrophotometer with an absorbance value at the same specific wavelength measured using a 100 μm-thick assembled cell and determining the thickness of the cosmetic layer by calculations instead of using a rotary wet film thickness gauge. Thus, a simpler and more accurate method for evaluating the UV transmission ratio of a cosmetic has been developed. Furthermore, since the calculation formulas for determining the SPF value and the UVA-PF value from the absorbance are not calculation formulas specified by the ISO methods, measurement results having a higher correlation with human test data could be obtained. Note that, hereinafter, an UV transmission ratio evaluation substrate may be simply referred to as a “substrate” depending on the case.

1. A method for evaluating UV protection performance of a cosmetic, the method including a preparation step of preparing a measurement sample for evaluating UV protection performance of a cosmetic, wherein the preparation step is a step including forming a uniform cosmetic application layer of the cosmetic on an UV-transmittance-measurement transparent substrate surface with an applicator having a material layer with a surface having an oil adhesion prevention property.

2. The method for evaluating UV protection performance of a cosmetic according to 1, wherein the material layer with the surface having the oil adhesion prevention property is a layer formed of one or more selected from a polyethylene naphthalate (PEN) film, a hydrophilized polyester film, a hydrophilized polyethylene terephthalate film, and a fluororesin film, which have the oil adhesion prevention property.

3. The method for evaluating UV protection performance of a cosmetic according to 1 or 2, including the following steps A to D:
A: the preparation step comprising a step of preparing a plurality of measurement samples of one type of cosmetic for evaluating UV protection performance of the cosmetic by forming a plurality of uniform cosmetic application layers on surfaces of a plurality of types of UV-transmittance-measurement transparent substrates having different contact angles, respectively, using the applicator including the material layer with the surface having the oil adhesion prevention property;
B: a step of determining an absorbance of the cosmetic at a reference thickness using an assembled cell, and determining an SPF (Sun Protection Factor) value and a UVA-PF (Protection grade of UVA) value of each measurement sample by the following formulas or equivalents thereto:
an SPF value obtained by performing integration for every 1 nm from 290 to 320 nm using a formula CF×ΣEE(λ)×I(λ)×Abs(λ),
a UVA-PF value obtained by performing integration for every 1 nm from 320 to 400 nm using a formula CF×ΣEE(λ)×I(λ)×Abs (λ),
where CF represents a correction factor (=10), EE represents an erythemal effect spectrum, I represents a solar intensity spectrum, and Abs represents an absorbance, of a sunscreen product (i.e., each measurement sample);
C: a step of selecting, on a basis of the SPF values obtained for the plurality of measurement samples, a measurement sample with a maximum SPF value and defining the SPF value and the UVA-PF value of the selected measurement sample as an in vitro SPF value and an in vitro UVA-PF value, respectively, of the one type of cosmetic;
D: a step of determining an in vivo SPF equivalent value of the one type of cosmetic from a predetermined relational expression between an in vivo SPF value and the in vitro SPF value, and further determining an in vivo UVA-PF equivalent value of the one type of cosmetic from a predetermined relational expression between an in vivo UVA-PF value and the in vitro UVA-PF value.

4. The method for evaluating UV protection performance of a cosmetic according to 3, wherein the plurality of types of UV-transmittance-measurement transparent substrates having different contact angles are the following three types of substrates: an UV-transmittance-measurement transparent substrate having, on a surface thereof, a layer formed by applying a polyisocyanate, an UV-transmittance-measurement transparent substrate having, on a surface thereof, a layer formed by applying inulin, and an UV-transmittance-measurement transparent substrate having, on a surface thereof, a layer formed by applying a hydroxyalkyl cellulose.

5. The method for evaluating UV protection performance of a cosmetic according to 3 or 4, wherein the relational expression between the in vivo SPF value and the in vitro SPF value and the relational expression between the in vivo UVA-PF value and the in vitro UVA-PF value are determined by statistically processing relationships between (i) SPF values and UVA-PF values obtained by in vivo methods or in vivo UVA-PF values corresponding to a PA (Protection Grade of UV-A) classification, of property-known cosmetics (e.g., commercially available cosmetics), and (ii) SPF values and UVA-PF values of the cosmetics determined in accordance with the steps A to D.

6. The method for evaluating UV protection performance of a cosmetic according to any one of 1 to 5, wherein the cosmetic is a powder cosmetic, a stick-like cosmetic, or a paste-like substance obtained by mixing a non-volatile oil with a solid cosmetic.

It should be noted that the present invention (which generally means the present disclosure, and may refers to some embodiments) can equally be applied to a system for evaluating UV protection performance of a cosmetic.

Adopting the method for evaluating the UV transmission ratio of a cosmetic according to the present invention provides an advantageous effect in that among various forms of cosmetics such as solution-type cosmetics, emulsion-type cosmetics, powder cosmetics, paste-like cosmetics, and stick-type cosmetics, there is no form of cosmetics that cannot be evaluated, and more precise, accurate, and stable measured values are obtained for any form of cosmetics. In particular, powder cosmetics and stick-type cosmetics have not been subjected to measurements with high accuracy to date, and this method is the first to make it possible to measure all of the various forms of cosmetics mentioned above.

### BRIEF DESCRIPTION OF THE DRAWINGS

FIG. 1 is a flowchart of an evaluation method.

FIG. 2 is a graph illustrating an example of a heating time and a change in absorbance.

FIG. 3 is a photograph of the exterior of an assembled cell placed in a jig for installing in a spectrophotometer.

FIG. 4 is a perspective view of a metal applicator.

FIG. 5 is a view of a metal applicator, as viewed from below.

FIG. 6 is a cross-sectional view of a metal applicator.

FIG. 7 is a cross-sectional view of an application device used in an application step 2.

FIG. 8 is a perspective view of a cylindrical applicator.

FIG. 9 is a cross-sectional view of a cylindrical applicator.

FIG. 10 is an observation example with an infrared imaging microscope of a coating film applied using a stainless-steel cylindrical applicator.

FIG. 11 is an observation example with an infrared imaging microscope of a coating film applied using a cylindrical applicator in which a hydrophilized polyethylene terephthalate film is fixed to a surface that comes in contact with a cosmetic during application.

FIG. 12 is an observation example with an infrared imaging microscope of a coating film applied using a cylindrical applicator in which a polyethylene terephthalate film that is not hydrophilized is fixed to a surface that comes in contact with a cosmetic during application.

FIG. 13 is an observation example with an infrared imaging microscope of a coating film applied using a cylindrical applicator in which a polyimide tape is fixed to a surface that comes in contact with a cosmetic during application.

FIG. 14 is an observation example with an infrared imaging microscope of a coating film applied using a cylindrical applicator in which a polyvinyl chloride tape is fixed to a surface that comes in contact with a cosmetic during application.

FIG. 15 is an observation example with an infrared imaging microscope of a coating film applied using a cylindrical applicator in which silicone rubber is fixed to a surface that comes in contact with a cosmetic during application.

FIG. 16 is an observation example with an infrared imaging microscope of a coating film applied using a cylindrical applicator in which a polyethylene naphthalate film is fixed to a surface that comes in contact with a cosmetic during application.

FIG. 17-1 is the table of APPENDIX I of Non Patent Literature 4.

FIG. 17-2 is the table of APPENDIX I of Non Patent Literature 4.

FIG. 17-3 is the table of APPENDIX I of Non Patent Literature 4.

### DESCRIPTION OF THE SYMBOLS

1: spreading device
2: spreading member
3: support part
4: substrate
5: excess cosmetic
6: spreading member tip part
7: cylindrical applicator
8: support part
9: spreading device
B: base
P: support
S: resin sponge-like coating tool

### DETAILED DESCRIPTION OF EMBODIMENTS

Hereinafter, the present invention will be described in detail.

A method for evaluating an UV transmission ratio, the method including a step of preparing a measurement sample for evaluating UV protection performance of a cosmetic, according to the present invention is a measurement method for obtaining highly accurate and stable UV protection factors for various cosmetics such as emulsions including hydrophilic and lipophilic emulsions, lotions, emulsified foundations, powder cosmetics, oil-based cosmetics, and sprays.

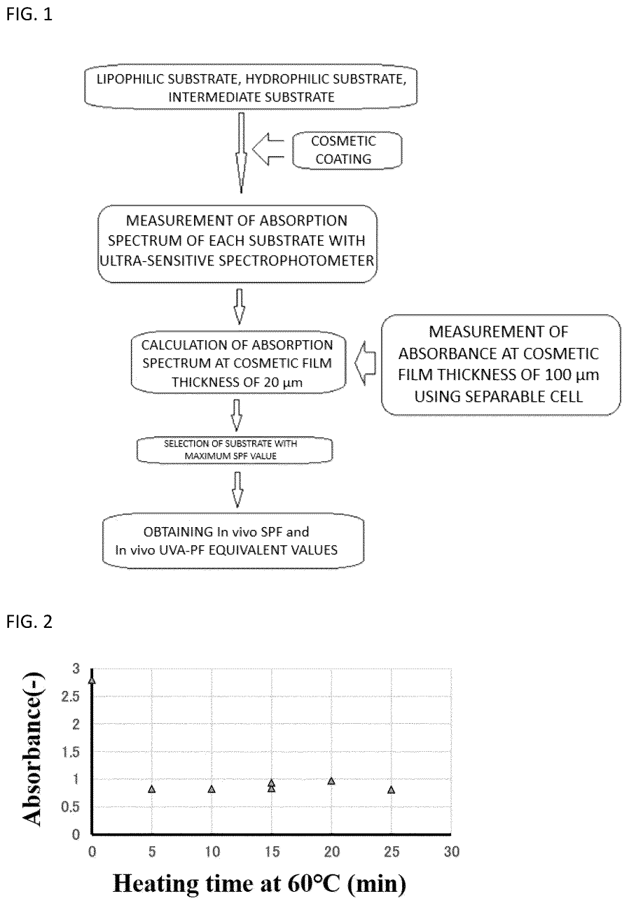

As illustrated in FIG. 1, in the present invention, a, a plurality of types of substrates, for example, three types of substrates; an inulin-treated substrate (hydrophilic substrate), a hydroxyalkyl cellulose-treated substrate (intermediate substrate), and a polyisocyanate-treated substrate (hydrophobic) substrate (lipophilic substrate) are prepared as transparent substrate surfaces for measuring an UV transmittance (hereinafter referred to as “UV-transmittance-measurement transparent substrate surfaces”). A cosmetic to be evaluated is applied to the substrates by sequentially performing, for example, coating steps 1, 2, and 3. Spectra of UV light transmitted through the substrates are measured. These are corrected to spectra when the thickness of the cosmetic is, for example, 20 μm. In this case, the spectra are determined with reference to the absorbance when the thickness of the cosmetic is 100 μm, the absorbance being separately determined using an assembled cell.

Subsequently, among the three types of substrates, a substrate with a highest SPF value is selected.

The method is based on obtaining values equivalent to in vivo-SPF and in vivo-UVA-PF using predetermined formulas based on the SPF value and the UVA value obtained when the substrate with the highest SPF value is used.

### Cosmetics

The cosmetics in the present invention are a wide range of cosmetics including makeup products and basic cosmetics. Specific examples thereof include makeup cosmetics such as hydrophilic (O/W) emulsified sunscreen products, lipophilic (W/O) emulsified sunscreen products, multilayer (O/W/O, W/O/W) emulsified sunscreen products, and emulsified foundations; makeup bases, sunscreen creams, multi-layer separation-type sunscreen products, non-chemical sunscreen products, day essences, day care lotions, hand creams; powder cosmetics such as solid foundations, whitening powders, blushers, and eye shadows; oil-based cosmetics such as lipsticks and stick-type sunscreens; spray-type sunscreen products, and roll-on-type sunscreen products. Examples of the types of formulations include liquid, emulsion, cream, lotion, essence, multilayer separation form, oil, powder, and sheet. However, cosmetics whose UV transmission ratio is obviously 0% or obviously 100% are not included. This cosmetic and the like are applied to the skin, preferably at least one of the face, body, limbs, etc. to obtain a UV protection effect.

In general, this UV protection effect is represented as an SPF value corresponding to UV B rays having a wavelength of 290 to 320 nm, an UVA-PF value corresponding to UV A rays having a wavelength of 320 to 400 nm, an in vivo UVA-PF value corresponding to the PA classification, or a PPD value but may be represented as any other index that indicates the protective effect of these wavelengths.

An UV absorbent added to exhibit UV absorptivity may be any UV absorbent added to cosmetics. Among such UV absorbents, examples of oil-soluble ones include cinnamic acid-based UV absorbents, triazine-based UV absorbents, benzophenone-based UV absorbents, benzoic acid-based UV absorbents, salicylic acid-based UV absorbents, and dibenzoylmethane-based UV absorbents. These may be used alone or in combination of two or more thereof. Water-soluble ones may be, for example, benzophenone-based UV absorbents or phenylbenzimidazole sulfonic acid and/or 2-hydroxy-4-methoxybenzophenone sulfonic acid. Examples of UV absorbents that are solid at room temperature include methylene bis-benzotriazolyl tetramethylbutylphenol trisbiphenyltriazine, and the like.

Examples of pigments that may be contained in the cosmetics and that scatter and absorb UV rays include fine-particle titanium oxide, fine-particle zinc oxide, fine-particle cerium oxide, titanium oxide, zinc oxide, titania hydroxide sol, aluminum powder, and gold foil powder.

Furthermore, the cosmetics contain, as ingredients other than these UV absorbents and/or pigments, various ingredients that can be blended in cosmetics.

### UV-Transmittance-Measurement Transparent Substrate Surface

As UV-transmittance-measurement transparent substrate surfaces, a plurality of types of UV transmission ratio evaluation substrates having different contact angles are used. In particular, two or more types of substrates selected from three types of substrates (a lipophilic substrate, an intermediate substrate, and a hydrophilic substrate) are used. For example, such three types of substrates are used to obtain a plurality of measurement samples. The three types of substrates have contact angles to pure water different from each other. The contact angle of each of the UV transmission ratio evaluation substrates in the present invention is a contact angle at 25° C. to pure water on the substrate surface. Hereinafter, an UV-transmittance-measurement transparent substrate surface is referred to as an “UV transmission ratio evaluation substrate” in some cases.

The UV transmission ratio evaluation substrates are formed of a plurality of plates that are produced by processing, for example, ultra-smooth treated quartz plates and that have, on surfaces optionally subjected to a hydrophilic pretreatment, a lipophilic pretreatment, or the like, a lipophilic layer, a hydrophilic layer, and a contact angle-adjusting layer having an intermediate property exhibiting a contact angle between properties of these. In particular, the above three types of substrates are preferred and transmit UV rays in the range of 290 to 400 nm. It is also necessary to have excellent stability over time.

The hydrophilic pretreatment is performed by subjecting a plate to a treatment by physical means, such as a plasma treatment, an arc discharge treatment, or a corona-discharge treatment to provide a hydrophilic substrate having a contact angle to pure water in a range of 0° to 20°, preferably 0° to 10°, more preferably 0° to 5°. Detailed conditions for these treatments, such as the voltage applied and the treatment time, can be determined as appropriate depending on the desired contact angle. Furthermore, regarding the atmosphere, a corona-discharge treatment in air, or a plasma discharge treatment in vacuum or an oxygen or argon atmosphere can be performed. In particular, a quartz substrate is preferably subjected to a corona-discharge treatment.

The lipophilic pretreatment can be performed by coating a plate surface with a compound for exhibiting lipophilicity or by subjecting a plate surface to a plasma treatment, an arc discharge treatment, a corona-discharge treatment, or the like in an atmosphere of a reactive compound having lipophilicity.

It should be noted that a plate made of a material that is easily deformed by external force, such as polymethyl methacrylate, is not preferable because the plate is likely to deform during coating of a cosmetic or washing, and it may not be possible to stably prepare or use an UV transmission ratio evaluation substrate. Therefore, a plate that has high mechanical strength and that transmits UV rays in the range of 290 to 400 nm uniformly over its entire wavelength range, such as a quartz plate, is preferred.

In order to obtain the above three types of substrates based on the plates, three different types of contact angle-adjusting layers are formed for each of the three plates to obtain UV-transmittance-measurement transparent substrates.

Note that in the present invention, to accurately evaluate the UV transmittance, each of the three types of contact angle-adjusting layers formed on the surfaces of the plates need to be smooth. As for the degree of smoothness, according to the results determined by the following inspection method, the height of irregularities is preferably 1 μm or less at the maximum.

### Method for Inspecting Irregularities

A test liquid (27% by weight of isononyl isononanoate, 6% by weight of ethylhexyl methoxycinnamate, 15% by weight of a titanium oxide dispersion, 50% by weight of vaseline, and 2% by weight of sorbitan isostearate) was thinly applied to a plate (quartz plate). Subsequently, a stainless-steel applicator with a gap of 1 um and a width of 10 cm was placed on the applied layer of the test liquid and moved slightly parallel to the plate surface to fit the surface of the applicator onto the applied layer of the test liquid. After the applied layer is further precisely leveled using the applicator at a speed of 5 mm/s, the resulting coating film is viewed through light. If there is no shading in the resulting coating film, it is considered that the plate surface has no irregularities and a lipophilic substrate, an intermediate substrate, and a hydrophilic substrate prepared as described below are also free of irregularities, and the plate is considered to pass the inspection.

### Lipophilic Substrate

The lipophilic substrate is obtained by smoothing the above plate surface, performing a lipophilic pretreatment as necessary, and forming a lipophilic treatment layer so that the contact angle at 25° C. to pure water is in the range of 75° to 85°. As the lipophilic treatment layer, typical urethane resins and urethane acrylates exhibit higher contact angles; therefore, it is necessary to blend another component that decreases the contact angles. Also, acrylic resins are not suitable because acrylic resin grades that can be used for coatings often have UV absorption in the wavelength range of 290 to 400 nm. Similarly, UV curable resins are not suitable because resins after curing often have some absorption in the wavelength range of 290 to 400 nm.

In view of the above, as resins which can be applied smoothly and whose contact angles to pure water can be adjusted by adjusting the components and adding other components, acrylic-based polyisocyanates, polyurethanes, polyurethane acrylates, and copolymers of thiol compound/isocyanate compound/acrylate compound that may be moisture-curable are preferably adopted. These resins have, in a portion of the molecular structures, a hydrophilic polyol, acrylate, or hydroxy group-containing acrylate. The adjustment of the blending ratio of the component of this polyol, acrylate, or hydroxy group-containing acrylate enables the contact angle to pure water to be adjusted to 75° to 85°.

### Intermediate Substrate

The intermediate substrate is obtained by smoothing the above plate surface, performing a hydrophilic pretreatment, a lipophilic pretreatment, or the like as necessary, and forming a layer having an intermediate property between hydrophilicity and lipophilicity. The surface of the intermediate substrate suitably has a contact angle at 25° C. to pure water in the range of 50° to 60°. In the intermediate substrate in which the contact angle changes immediately after the formation of the layer having the intermediate property between hydrophilicity and lipophilicity, it is necessary to apply a cosmetic immediately after the formation of the layer having the intermediate property between hydrophilicity and lipophilicity.

The layer having the intermediate property between hydrophilicity and lipophilicity necessary for obtaining such an intermediate substrate is preferably formed of a hydroxyalkyl cellulose (with a contact angle immediately after application of 51° to 52°). Alternatively, one or more may be selected from the following compounds and applied to the plate surface to form the layer: compounds having a sugar skeleton, such as mannose, galactose, xylose, glucose, maltose, lactose, sucrose, trehalose, fructose, cellulose, cellulose derivatives such as hydroxyethyl cellulose, hydroxypropyl cellulose, and carboxymethyl cellulose, trisaccharides such as maltotriose and raffinose, tetrasaccharides such as inulin, oligosaccharides, glucan, agar, a-cyclodextrin, maltodextrin, corn starch, kudzu starch, tapioca starch, potato starch, wheat starch, hydroxyethyl starch, hydroxypropyl starch, tamarind gum, xanthan gum, native gellan gum, and gellan gum, which are solubilized as necessary.

Note that sugar alcohols such as erythritol and xylitol, compounds derived from sugar, and other non-sugar compounds may be blended as long as the effects of the present invention are not impaired or may not be blended.

Furthermore, from the viewpoint of constituting the layer, preferably, the compounds are solid at normal temperature and pressure, do not have deliquescence, and are not insoluble in water at room temperature. The term “not insoluble” refers to a case of having a solubility in water at room temperature of 1 g/100 mL or more. Furthermore, ones having a solubility of 5 g/100 mL or more are more preferable.

### Hydrophilic Substrate

The hydrophilic substrate is obtained by performing a selection from the various compounds and a plurality of combinations of the various compounds that are used for obtaining the intermediate substrate, and forming a layer on the plate.

In particular, a layer that exhibits hydrophilicity can be formed using a tetrasaccharide such as inulin or a hydroxyalkyl cellulose. In the case of using inulin, the contact angle at 25° C. to pure water immediately after application is 23° to 26°, and the contact angle five minutes immediately after application is 0° to 2.5°. The stability over time is also excellent.

In the method for evaluating UV protection performance of a cosmetic according to the present invention, a cosmetic is thinly applied to three types of substrates (a lipophilic substrate, an intermediate substrate, and a hydrophilic substrate), which are UV transmission ratio evaluation substrates, to prepare measurement samples. The method is based on measuring the measurement samples using a spectrophotometer. The outline of the measurement method is illustrated in FIG. 1 and is described with reference to a case of an emulsion sunscreen product.

[A. Preparation step of preparing a plurality of measurement samples for evaluating UV protection performance of cosmetic by forming uniform cosmetic application layer on surfaces of a plurality of types of UV transmission ratio evaluation substrates having different contact angles using one type of cosmetic with applicator including material layer with surface having oil adhesion prevention property]

### Coating of UV Transmission Ratio Evaluation Substrates With Cosmetic

A coating step 1 and/or a coating step 2 described below, etc. are performed as appropriate, and a coating step 3 described below is then performed as a preparation step. As a result, measurement samples are prepared.

### Coating Step 1

For a surface of a UV transmission ratio evaluation substrate, a cosmetic is applied to the UV transmission ratio evaluation substrate using a metal applicator with a gap of 500 μm to 1,000 μm. In this case, the UV transmission ratio evaluation substrate is placed on, for example, a support substrate made of extra super duralumin or the like having a thickness in the range of 4 to 10 mm, and coating is performed such that a moving speed relative to the metal applicator is a speed of 1 to 10 mm/sec, for example, 5 mm/sec. The cosmetic may be spread in advance on the UV transmission ratio evaluation substrate using a spatula for painting or the like and then leveled with the metal applicator as needed.

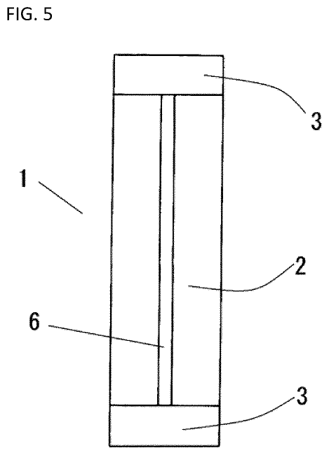

As an example of the metal applicator, one illustrated in FIGS. 4 to 6 can be adopted.

The metal applicator is moved by, for example, a spreading device 1 illustrated in FIG. 4.

The spreading device 1 is a device including a spreading member 2 and support parts 3 that support both ends of the spreading member 2.

The spreading member 2 is configured to be supported with respect to the support parts 3 by a structure (not shown), for example, fitting pins provided at both end portions of the spreading member into grooves extending in the vertical direction and provided in the support parts 3 so that the spreading member 2 can move freely up and down, and to resist drag received from the cosmetic to be spread by the self-weight of the spreading member to uniformly apply the cosmetic to the substrate.

For the spreading device 1 illustrated in FIG. 4, other members are not illustrated for the sake of explanation; however, in order to integrate as a spreading device, for example, a member angle that connects the two support parts 3 together may be provided.

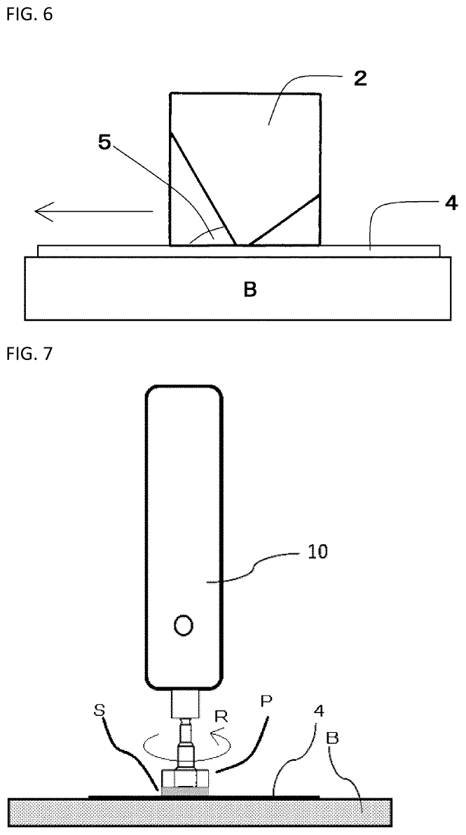

Also, FIG. 5 is a view of the spreading device 1 as viewed from the lower surface (view when the upper spreading member 2 is viewed from a base B side in FIG. 6), and a spreading member tip part 6 is located at the tip part of the spreading member 2.

The material of the spreading member 2 and the support parts 3 included in the spreading device 1 is preferably metal, particularly preferably a material that has good dimensional accuracy and that can be worked, such as stainless steel or duralumin. The spreading member used in the present invention preferably has a polygonal cross-sectional shape.

FIG. 6 is a cross-sectional view illustrating a state during coating with the metal applicator. In FIG. 6, a base B for fixing a substrate 4 is provided. Furthermore, as illustrated in FIG. 6, the angle formed by a surface of the spreading member, the surface being oriented in the traveling direction of the spreading device indicated by the arrow, and the surface of the substrate 4 to be coated needs to be 30° or more. If the angle is less than 30°, the film thickness may not be uniform due to drag applied to the spreading member by a cosmetic 5, and the measurement accuracy may be lowered depending on the cosmetic. Similarly, as in the case where the spreading member has a cylindrical shape or an elliptical cylindrical shape, when the spreading member has a shape in which the angle formed by a part of the spread member closest to the substrate and the surface of the substrate to be coated is close to 0°, the film thickness is not uniform due to drag applied to the spreading member.

The height of a gap formed between the spreading member tip part 6 and the substrate 4 is preferably in the range of 500 μm to 1,000 μm in the coating step 1.

When the spreading member is used alone, the mass of the spread member is preferably 100 g or more, more preferably 250 g or more. If the mass is small, the spreading member is likely to be affected by drag, which may make it impossible to form a smooth film. Also, if the mass is excessively large, the substrate and the plate supporting the substrate are distorted, and the substrate is no longer flat, which may result in a change in the film thickness depending on the coated portion. It is difficult to say exactly how much mass can be applied because it also depends on the strength of the substrate and the supporting plate. However, in the case of using extra super duralumin with a thickness of 5 mm, it has been observed that when a load is applied from above the spreading member and the load combined with the self-weight exceeds 2 kg, the distortion of the substrate appears as a non-negligible magnitude.

### Coating Step 2

An application device used in the coating step 2 includes a cylindrical support P with a diameter of 30 to 40 mm at a tip of a rotating shaft, as illustrated in FIG. 7. A shaft passing through the center of circular end faces at both ends of the cylindrical support is connected to the rotating shaft. A resin sponge-like coating tool S having, for example, a rectangular parallelepiped shape with a width of 8 to 12 mm, a length of 30 to 35 mm, and a height of 8 to 12 mm is fixed to the support. In this case, the surface of the resin sponge-like coating tool S is a flat surface, and the flat surface is used so as to be parallel to the surface of an UV transmission ratio evaluation substrate 4. Subsequently, while the resin sponge-like coating tool is rotated (for example, at 200 to 250 rpm in the R direction), leveling is performed for a predetermined time such that the resin sponge-like coating tool is in contact with the layer (that is present between the resin sponge-like coating tool S and the UV transmission ratio evaluation substrate 4, although not illustrated in FIG. 7) formed of the cosmetic applied to the surface of the UV transmission ratio evaluation substrate 4 in the coating step 1, thereby making the cosmetic layer formed in the coating step 1 into a thinner coating layer. It should be noted that, in this case, the surface of the resin sponge-like coating tool preferably has an area larger than that of the UV transmission ratio evaluation substrate, or the length of the resin sponge-like coating tool S is preferably longer than the width or the diameter of the UV transmission ratio evaluation substrate, so that end portions of the sponge-like coating tool do not come in contact with the coating layer of the cosmetic (in FIG. 7, both ends of the resin sponge-like coating tool S protrude from end portions of the UV transmission ratio evaluation substrate 4). The sponge-like coating tool is preferably formed of a urethane sponge.

### Coating Step 3 (Preparation Step)

As a preparation step, for the cosmetic application layer surface obtained in the coating step 2, a layer (material layer that prevents fat and oil from selectively adhering to the surface of the applicator) formed of a material with a surface having an oil adhesion prevention property, the material having a property necessary for maintaining the dispersion state of an oil contained in the cosmetic or an oil used for making the cosmetic into a measurement sample and another substance dispersed with these oils (material having a property of capable of substantially maintaining the dispersion state of these oils and the other substance dispersed) is formed on, for example, a surface of a cylindrical applicator. Hereinafter, this layer is referred to as a layer or film that inhibits oil adsorption. Furthermore, coating is performed at a speed of about 5 mm/s using a modified applicator which is an applicator having this film fixed with a double-sided tape and having a gap of 20 to 30 μm with respect to the UV transmission ratio evaluation substrate surface to prepare a measurement sample. Here, the layer or film that inhibits oil adsorption is formed of a material with a surface having an oil adhesion prevention property. Through this coating step 3, a measurement sample including a more uniform cosmetic application layer is obtained.

It should be noted that since the coating step 3 is a step of forming a thin film of a cosmetic layer, it is necessary to limit the material of the surface of the applicator as described above. The coating steps 1 and 2 are steps of forming a thicker cosmetic layer. Therefore, for the application devices used in the coating steps 1 and 2, unlike the coating step 3, the material of the surface of the applicator is not limited to a material having water repellency or a property of capable of substantially maintaining the dispersion state of the oils and another substance dispersed.

The material with a surface having an oil adhesion prevention property used in the coating step 3 is required to have the above-described property, to have a uniform film thickness when formed into a material layer, and not to tear or wrinkle during coating. According to the results of examining the materials shown in Table 1, hydrophilized films and layers such as hydrophilized polyester films and layers and hydrophilized polyethylene terephthalate films and layers, and films and layers formed of a fluororesin such as polyvinylidene fluoride or polyethylene naphthalate (PEN) are preferred. As for fluororesins, in addition to polyvinylidene fluoride, tetrafluoroethylene, fluorinated ethylene propylene polymers, perfluoroalkoxy polymers, ethylene tetrafluoroethylene copolymers, ethylene chlorotrifluoroethylene copolymers, polychlorotrifluoroethylene, and polyvinyl fluoride are also preferred. Layers formed of any of these materials could be used, and a polyethylene naphthalate (PEN) film having particularly high durability was the most preferred. Layers formed of fluororesins also showed good results. Although stainless steel has a contact angle with water of 90°, stainless steel may destroy, for example, the emulsion of an emulsion-based cosmetic, and consequently, it may not be possible to form a uniform coating film.

The contact angles with water shown in Table 1 are contact angles with pure water at 25° C.

Subsequently, an applicator was prepared by applying a resin film such as a PEN film (as a material with a surface having an oil adhesion prevention property) having a thickness of 25 μm and a height of irregularities of 1.0 μm or less to a stainless steel cylindrical applicator with a gap of 100 μm using NICETACK manufactured by NICHIBAN Co., Ltd. (weakly adhesive, thickness: 60 μm) such that there were no wrinkles, and further flattening the surface with a plastic scraper. Incidentally, the applicator coated with the resin film such as a PEN film had a light weight of 266 g, and a phenomenon in which, in a cosmetic having a high viscosity, the applicator floated during coating and the film thickness was not uniform was confirmed. Accordingly, a stainless-steel block with a weight of 248 g was placed on the applicator, and coating was performed at a total weight of 508 g. In particular, since the height of irregularities was 1.0 μm or less, a cosmetic layer having a smooth surface could be formed. Note that the smoother the surface of the resin film, the smoother the formed cosmetic layer surface, and the subsequent measurement accuracy can be improved. It should be noted that this property does not change even when cosmetics have different properties, such as a liquid and a solid. In addition, all of the above materials described as the materials with a surface having an oil adhesion prevention property showed results similar to the results obtained in Examples described below as in the PEN.

It should be noted that the metal applicator with a gap of 500 μm to 1,000 μm used in the coating step 1 does not require any special processing. The problem of floating of the applicator during coating becomes obvious when the gap of the applicator is narrow and thus is likely to occur in the coating step 3, but the coating step 1, which is performed with a large gap, does not require any special measures.

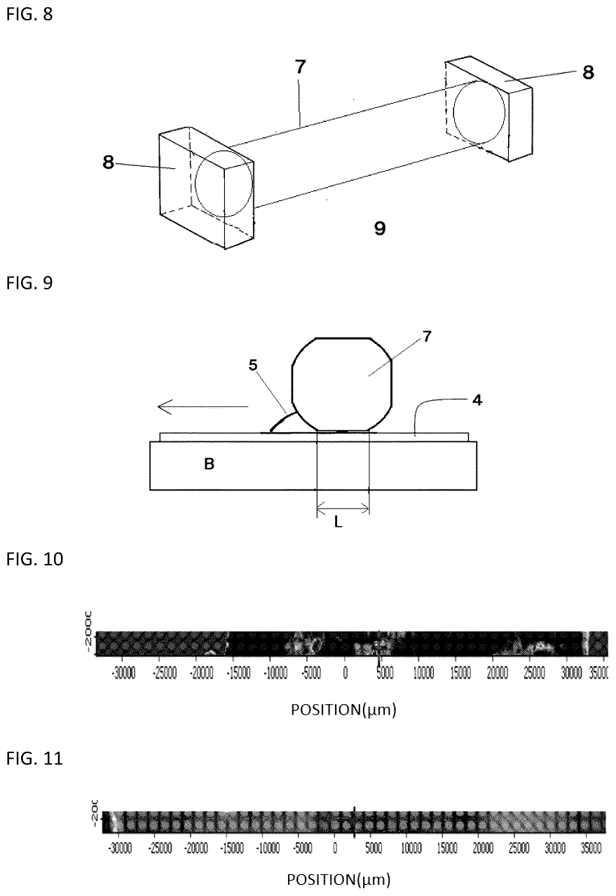

FIG. 8 illustrates an example of the cylindrical applicator.

A cylindrical applicator 7 is moved by, for example, a spreading device 9 illustrated in FIG. 8.

The spreading device 9 is a device including a cylindrical applicator 7 and support parts 8 that support both ends of the cylindrical applicator 7. The spreading device 9 is supported by the support parts 8 or the like so as to be fixed to a frame (not shown) or the like or to allow a movement necessary for spreading.

The cylindrical applicator 7 is supported with respect to the support parts 8 by a structure (not shown), for example, fitting pins provided at both end portions of the cylindrical applicator 7 into grooves extending in the vertical direction and provided in the support parts 8 or by integrally forming the whole, so that the cylindrical applicator 7 can move freely up and down. The cylindrical applicator 7 is configured to resist drag received from the cosmetic to be spread by the self-weight of the cylindrical applicator 7 to uniformly apply the cosmetic to the substrate. Alternatively, the cylindrical applicator 7 may be fixed to the support parts 8. The cylindrical applicator 7 may be obtained by, for example, cutting a single metal block to provide one without joints or may be obtained by, for example, assembling appropriate members.

For the spreading device 9 illustrated in FIG. 8, other members are not illustrated for the sake of explanation; however, in order to integrate as a spreading device 9, for example, a member angle that connects the two support parts 8 together may be provided.

The cylindrical applicator 7 illustrated in FIG. 8 has a shape in which the spreading member 2 of the metal applicator described above is replaced with the cylindrical applicator 7.

In the cylindrical applicator 7, the shape of a cross section perpendicular to the length direction of the cylinder may or may not be strictly a circular shape. The cylindrical applicator 7 may have a circular shape, may have a shape with four chords in a circular shape in which the portions of the chords are flat, as illustrated in FIG. 9, or may have a fan shape. Furthermore, instead of the shape based on a circular shape illustrated in FIG. 9, the cross section may be an elliptical shape, or may be a shape in which two circles, ellipses, or the like overlap and which has a partially flat surface. It is only necessary that a portion of the cross section that comes in contact with a cosmetic be a gentle curve or a horizontal surface. The cylindrical shape of the portion that comes in contact with a cosmetic is not particularly limited; however, the shape of the portion that comes in contact with the cosmetic during application may be a curved surface that reflects a cylindrical shape with a cross-sectional diameter of 10 to 30 mm or a curved surface that reflects a cross section which is close to such a curved surface and is not a circle, such as an elliptical shape. In the case of a horizontal surface, the width of a minor axis (in FIG. 9, with respect to the above-described gentle curve or horizontal surface facing a base B, a length L in a direction parallel to the arrow indicating a direction in which the cylindrical applicator moves relative to the substrate) is preferably 1.0 to 5.0 mm, more preferably 1.0 to 3.0 mm.

FIG. 9 is a view illustrating a state when the cylindrical applicator 7 is moved in the arrow direction in application of a cosmetic with the cylindrical applicator 7. As with the metal applicator (FIGS. 4-6), the applicator is moved relative to the surface of a cosmetic application layer. The portion corresponding to the spreading member tip part 6 in the metal applicator is the substantially horizontal portion of the lower end of the cylindrical applicator 7 in FIG. 9, and when the cylindrical applicator moves in the arrow direction with the lower end portion, an excess cosmetic 5 thereby also moves in the same manner. In this case, a gap formed by the cylindrical applicator 7 and the surface of a substrate 4 is preferably in the range of 500 μm to 1,000 μm in the coating step 1.

Although the above-described film that inhibits oil adsorption on the surface of the cylindrical applicator is not illustrated in FIG. 8, the film may cover the surface of the cylindrical applicator 7 so as to wind around the whole of the cylindrical applicator 7 in FIG. 8, or so as to cover only a portion also coming in contact with the excess cosmetic 5 in a lower portion of the cylindrical applicator 7 in FIG. 8. When the surface of the cylindrical applicator is covered with a layer formed of the material with a surface having an oil adhesion prevention property, for example, the film wrapped around the surface of the cylindrical applicator may be fixed with a double-sided adhesive tape only in an upper portion of the cylindrical applicator 7 that does not come in contact with the excess cosmetic 5. Even in the case where only a lower portion of the cylindrical applicator 7, the portion also coming in contact with the excess cosmetic 5, is covered with the film, the film can be fixed using a double-sided adhesive film only in the portion that does not come in contact with the excess cosmetic 5. Note that, as the means for fixing the film to the cylindrical applicator, other known means for fixing a film to an object (such as clipping members such as clips and fixing with an adhesive) can be adopted instead of the fixing with a double-sided tape.

Here, the reason why it is essential that the surface be formed of a film or a layer of the material having an oil adhesion prevention property will be described. A coating film is prepared by applying, using a stainless-steel applicator having the shape illustrated in FIG. 4, a sunscreen product to a quartz plate that is made superhydrophilic by corona discharge, and confirming that the film thickness is uniform using a rotary film thickness gauge. For this coating film, imaging at 2,852 cm⁻¹, which is one of the property absorption wavenumbers of an UV absorbent, was performed using an infrared imaging microscope (iN10 MX infrared imaging system all-in-one FT-IR microspectrometer, manufactured by Thermo Fisher Scientific), and it was confirmed that the concentration of the UV absorbent changed depending on the location. This means that the assumption that if the film thickness of a cosmetic is uniform, the composition of the sunscreen product in the cosmetic is uniform regardless of the location of the coating film has collapsed. That is, in the case of using a stainless-steel applicator, the measured values include large errors. If coating can be performed using such a material that the concentration of an UV absorbent does not change depending on the location, errors can be significantly reduced, and accurate measurements can be performed. In view of this, coating was performed using various materials, and the distribution of an UV absorbent in the resulting coating films was measured using an infrared imaging microscope. As a result, it was found that the concentration of the UV absorbent did not change depending on the location or changed only slightly when materials with a surface having an oil adhesion prevention property were used. Conversely, since the uniformity of the coating film was maintained by these materials, the reason why the concentration of the UV absorbent changed depending on the location is considered to be the occurrence of the following phenomenon: since stainless steel is lipophilic, an oily ingredient in the sunscreen product adsorbs gradually on the surface of the stainless steel as the applicator travels, and when the amount of adsorption becomes equal to or more than a certain level, the oily ingredient falls to the substrate side.

### With Regard to Coating Steps in General

The coating step 1 is a pre-coating step for the coating step 2. Stability of the thickness of a film that can be applied by an applicator in the coating step 2 tends to depend on the amount of cosmetic on the front face of the applicator. Therefore, the coating step 1 is performed for the purpose of making the amount of cosmetic uniform. The user spreads a cosmetic such as a sunscreen product with his/her fingers or hands in actual use; therefore, the coating step 2 is performed to reflect this physical effect such as shearing for reducing the thickness. However, if the time required for the coating step 2 becomes long, volatile ingredients in the cosmetic evaporate and non-volatile ingredients in the cosmetic are concentrated. For this reason, the coating time is 8 to 14 seconds so that even a cosmetic that is difficult to be applied can also be uniformly applied. The coating step 3 is performed so that the cosmetic that has become non-uniform in the coating step 2 is made into a uniform coating film.

TABLE 1

| | Contact angle with pure |
|---|---|
| | water (°) |
| Stainless steel | 90 |
| Polyethylene (Medical tape) | 107 |
| Polyimide | 95 |
| Polyvinyl chloride | 100 |
| Polyethylene terephthalate | 83 |
| Silicone rubber | 105 |
| Rayon (Medical tape) | 139 |
| Paper (Medical tape) | 131 |
| Urethane (Medical tape) | 127 |
| Cotton (Medical tape) | 141 |
| Hydrophilized polyethylene terephthalate | 10 |
| Polyethylene naphthalate | 95 |
| Hydrophilized polyester | 7 |
| Polyvinylidene fluoride | 110 |

### Drying Step

After the coating step 3, the resulting sample is left to stand in a cool, dark place for one hour to one and a half hours. During this time, UV rays may be applied.

In countries other than Japan, the SPF values of commercially available sunscreen products are 100 to 150, and in order to measure these cosmetics, the performances of current SPF analyzers are insufficient. An ultra-sensitive spectrophotometer that can stably measure an absorbance up to about 5.5 is required, and in such an ultra-sensitive spectrophotometer, a sample needs to be installed so as to stand vertically due to the arrangement of the integrating sphere and the optical path. Accordingly, a drying step for a certain time is necessary to prevent a coated sample from dripping.

### Measurement of UV Absorption Spectrum of Measurement Sample

### Step of Measuring Absorption Spectrum of Cosmetic Applied to Each Substrate by Ultra-Sensitive Spectrophotometer

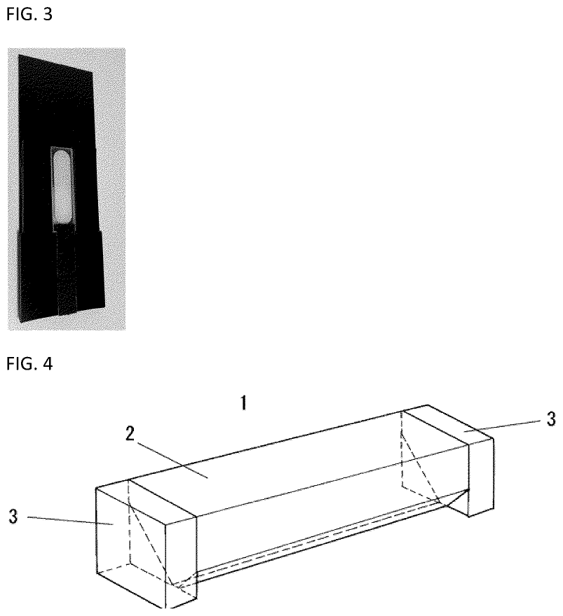

A 150 mm integrating sphere was installed in an UV visible spectrophotometer LAMBDA 850+ (measurement sensitivity, absorbance 8) manufactured by PerkinElmer. A assembled cell for a measurement sample was fixed to fit a hole in a central portion of an aluminum jig subjected to an alumite treatment in FIG. 3, as shown in the photograph of the exterior of a assembled cell placed in a jig for installing in the spectrophotometer in FIG. 3. This jig was fixed to the outside of a light-receiving part of the integrating sphere with a double-sided tape so as to be parallel to an opening of the integrating sphere. The absorbance in the range of 290 to 400 nm was measured with this device.

The reason why this UV visible spectrophotometer LAMBDA 850+ was used is that, in Materials Characterization: UV/Vis/NIR Spectroscopy; A Spectroscopic in vitro Method for the Calculation of Sunscreen SPF Values in resources.perkinelmer.com, measurement examples with LAMBDA 1050+, which has, in the UV region, a performance equivalent to that of LAMBDA 850+ manufactured by PerkinElmer, are described. That is, this is because there are already actual achievements of measuring the UV protection ability using this apparatus.

This operation was performed for each of the three types of measurement samples (the lipophilic substrate, the intermediate substrate, and the hydrophilic substrate). Note that it is preferable to acquire data at three different measurement points per measurement sample. Samples with a reference thickness (reference film thickness) are obtained as described below.

[B. Step of determining absorbance of cosmetic at reference thickness using assembled cell, and determining spf value and UVA-PF value by formulas below (cosmetics other than solid cosmetics)]

### Filling Assembled Cell With Sample

A jig capable of fixing a assembled cell (consisting of a pair of assembled quartz plates which are separable and one of which has a recess with a preset depth for accommodating a sample therein) (T-20-UV-0.1, demountable cell with removable window, manufactured by Tosoh Corporation) with an internal space thickness of 100 μm was prepared, and a female mold of the assembled cell (the cell in which a recess was formed) was placed in the jig. A sample was poured into the recess (depth: 100 μm) of the cell, and a flat and smooth quartz plate with a size of 100×100 mm was then gently pressed from above to remove air bubbles in the sample. Since the cell and the quartz plate were parallel to each other in this state, the quartz plate was horizontally shifted to obtain a reference film-thickness sample formed of the assembled cell filled with the sample to a thickness of 100 μm. Subsequently, the periphery and the back surface of the cell were cleaned. The reason for setting the thickness to 100 μm is that when an emulsion is measured at a thickness of 50 μm, the measured absorbance often varies greatly depending on the measurement position. This is because the ingredient composition in the emulsion differs greatly depending on the measurement position at a thickness of 50 μm. On the other hand, at a thickness of 500 μm, even when various cosmetics are measured, the absorbance does not vary depending on the measurement position. However, cosmetics having high SPF values may have an excessively high absorbance, and the Lambert-Beer law may not be satisfied. At a thickness of 100 μm, although a variation in absorbance was observed depending on the measurement position, the variation can be corrected by performing measurement a plurality of times, and thus an assembled cell with a thickness of 100 μm was selected as a reference thickness.

The reason why the method in which the cell and the smooth quartz plate are parallel to each other is employed as a method for filling the assembled cell with a sample is as follows. When the surface of the assembled cell was scraped off by a scraping method (a method of leveling the surface of the assembled cell by obliquely applying a quartz plate), there were some cosmetics that were scraped off in an amount larger than the original amount. It was found that, in such a case, the thickness was about 80 to 90 μm, and thus the above method was developed to avoid this.

### Step of Heating Reference Film-Thickness Sample

A precision hot plate was prepared and stabilized at 60° C. The above reference film-thickness sample was placed on the hot plate and left to stand for 15 minutes. After 15 minutes, the sample was collected to obtain a reference film-thickness sample. Usually, when a plurality of reference film-thickness samples are measured as a task, about 10 assembled cells are placed on a hot plate at the same time. Thus, it is necessary to use a laboratory hot plate that can precisely control the temperature to prevent unevenness of heat, and a large hot plate device is preferably used in order to avoid taking a wrong sample.

A reason why the reference film-thickness sample is heated is as follows: since the cosmetic of the reference film-thickness sample has a large thickness of 100 μm, even if the reference film-thickness sample is left to stand for one hour without heating, the state becomes different from that of the cosmetic on each of the above coated substrates. In particular, a change occurs in the residual amount of volatile ingredients. Accordingly, measurement was performed using some cosmetics. For example, as shown in FIG. 2 illustrating the relationship between the heating time at 60° C. and the absorbance of a sunscreen product, after heating for five minutes, volatile ingredients such as water and ethanol evaporate mostly, and thereafter, the absorbance does not change much in many cases. In FIG. 2, the absorbance was measured at different heating times. Note that two samples that were heated for 15 minutes were obtained, and the absorbance of each of the samples was measured. However, since it was found that some cosmetics required a little more time, to provide a margin, heating was performed for 15 minutes to sufficiently remove the volatile ingredients in the cosmetics. Note that in FIG. 2, the measurement was performed twice only for heating time of 15 minutes. The reason why the absorbance decreases significantly after heating for five minutes may be the following: In a milky lotion, because a portion where light scattering is caused by refraction of light at the interface between water and oil (which therefore appears white in visible light) is formed, when water is removed by heating, this scattered light decreases, resulting in a decrease in the absorbance.

### Step of Measuring Reference Film-Thickness Sample With Spectrophotometer

The assembled cell cannot be set directly in a spectrophotometer because of its small size of 12.5×45 mm. Therefore, a black plastic jig as shown in FIG. 3 was developed and placed so that the assembled cell could be placed in close contact with the opening of the integrating sphere of the spectrophotometer. The assembled cell was placed in an opening of the black plastic jig, and the absorbance at a wavelength of 400 nm was measured. It should be noted that the reason why the assembled cell is brought into close contact with the opening of the integrating sphere is that since some cosmetics scatter light, the influence of scattered light cannot be sufficiently reflected unless the assembled cell is brought into close contact with the integrating sphere.

The reason why light of 400 nm was used is that the light is the closest to visible light in the wavelength range of 290 to 400 nm used for measurement of UV rays and is a wavelength that is least affected by light scattering due to fine particles or the like. A wavelength of, for example, 660 nm can also be used if only the whiteness of cosmetics is measured; however, it is necessary to perform measurement separately from the wavelength range of 290 to 400 nm when the substrates are measured. Therefore, considering that there is a time limit for measuring the substrates within 1 to 1.5 hours after coating, the use of 400 nm is efficient. In addition, depending on cosmetics, there are products such as lotions that neither absorb nor scatter light with a wavelength of 400 nm. In such a case, the measurement wavelength is gradually shifted toward shorter wavelengths, for example, 380 nm, 360 nm, 340 nm, 320 nm, and 300 nm, and a wavelength that yields a significant difference in absorbance is selected.

In the assembled cell, in order to correct for measurement variations, the absorbance is preferably measured at two different positions within the assembled cell. Furthermore, it has been found that there are cosmetics that have variations in preparation of a reference film-thickness sample; therefore, it is also necessary to prepare a reference film-thickness sample a plurality of times. In a preferred example, two reference film-thickness samples are prepared, the absorbance is measured at two positions in each assembled cell to obtain four absorbance data, and the standard deviation/average value of the data is determined. If this exceeds 0.2, one reference film-thickness sample is added, and the average value of the absorbance at six points is then determined. This average value may be defined as the absorbance of the corresponding product at a thickness of 100 μm.

The absorbance of the corresponding sample at 100 μm is determined by the above operation. Subsequently, this value is multiplied by 0.2 to convert it to a value at 20 μm. This is an operation for comparing values at a thickness of 20 μm, which corresponds to 2 mg/cm², because in the in vivo SPF measurement method, a cosmetic is applied to the back of the human at a rate of 2 mg/cm² and measured values are obtained.

[C. Step of selecting, on the basis of SPF values obtained for plurality of measurement samples, measurement sample with maximum SPF value, and defining SPF value and UVA-PF value of the measurement sample as in vitro SPF value and in vitro UVA-PF value, respectively, of the one type of cosmetic (cosmetics other than solid cosmetics)]

Absorbance data at a total of nine points have been obtained for the substrates described above. Accordingly, for example, if the absorbance at 400 nm is used as a reference, the values of the absorbance at 400 nm at the nine points are compared with the values of the absorbance at 20 μm measured using the assembled cell to correct the entire measurement data to values at 20 μm. As for the correction method, the values can be simply calculated by proportional calculation for each wavelength from the ratio of the absorbance at 400 nm and the absorbance at 20 μm. The average value of the correction data for each wavelength is determined for each substrate to obtain one spectral data for each substrate, and an in vitro SPF value and an in vitro UVA-PF value are determined using this spectral data by calculations. Subsequently, among the three substrates, a substrate that exhibits the maximum SPF value is selected, and the SPF value and the UVA-PF value of the substrate are defined as the values of the product.

Suppose that a layer of a cosmetic after application is affected by a property of the substrate surface, such as hydrophilicity (lipophilicity), and the cosmetic is subjected to phase separation or dewetting. As a result, the substrate is likely to transmit UV rays as a whole. In other words, a substrate having a uniform cosmetic layer and the minimum transmittance of UV rays is the substrate with the maximum SPF value (UV transmission ratio evaluation substrate). Such a substrate is a substrate on which a layer of the cosmetic has been formed without a change in properties of the cosmetic composition compared with other substrates. Therefore, properties that the cosmetic originally has can be accurately measured by selecting the substrate with the maximum SPF value and then determining the SPF value and the UVA-PF value.

[D. Step of determining in vivo SPF equivalent value of the one type of cosmetic from relational expression between in vivo SPF value and in vitro SPF value, and further determining in vivo UVA-PF equivalent value of the one type of cosmetic from relational expression between in vivo UVA-PF value and in vitro UVA-PF value (common to cosmetics other than solid cosmetics, powder cosmetics, and stick-like cosmetics)]

Here, in determination of the in vitro SPF value and the in vitro UVA-PF value from the spectral data by calculations, the cosmetic industries often use an ISO standard calculation formulas described in Non Patent Literature 4. However, a study conducted by the inventors of the present invention (Miyuki Fujishiro, Shoichi Yahagi, Akihiro Kuroda, Taisuke Banno, Kouichi Asakura, “Investigation on the validity of in vitro UVA-PF evaluation method for sunscreen samples”, The 2nd World Congress on Oleo Science, (WCOS 2022)) demonstrates that the calculation formulas of the ISO methods cannot suitably reflect the difference in absorbance in the UVB region in some cases. Moreover, it was found that when the relationships between the UV protection values or indices indicated on the products using ISO standard calculation formulas and the calculated values obtained by the present invention were examined from the measurement results of 206 commercially available sunscreen products from around the world, for both the SPF value and the UVA-PF value, the coefficient of determination (R-squared value) of the linear regression model was very poor. Meanwhile, before the ISO standard calculation formulas were proposed (in 1979), other calculation formulas had been proposed mainly in the Middle East and South America (Elizangela Abreu Dutra et al., “Determination of sun protection factor (SPF) of sunscreens by UV Spectrophotometry”, Brazilian Journal of Pharmaceutical Sciences, 40, 3, 381-385, 2004). Specifically, an SPF for each wavelength is determined using the following formula: SPF=CF×ΣEE(λ) ×I(λ)×Abs(λ)(Formula 1)

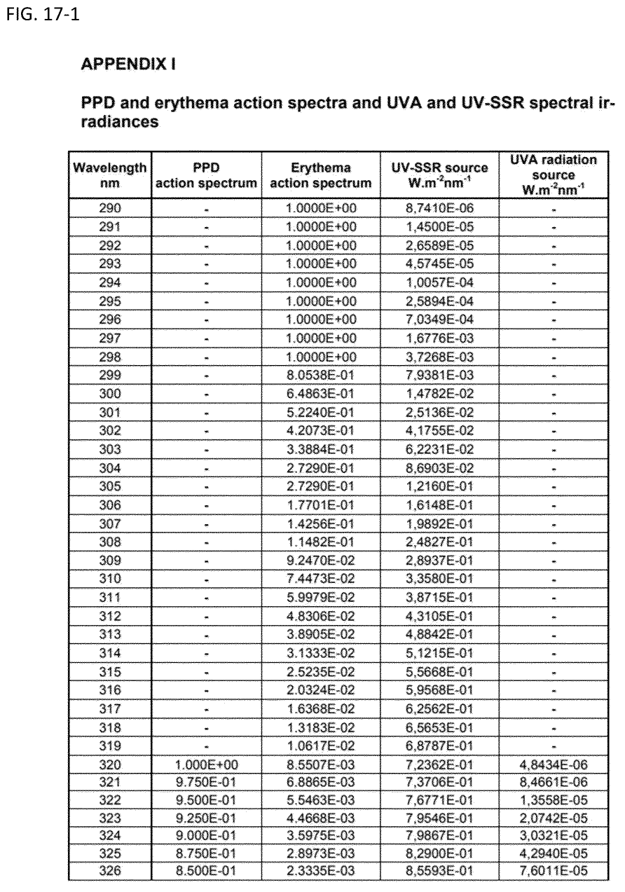

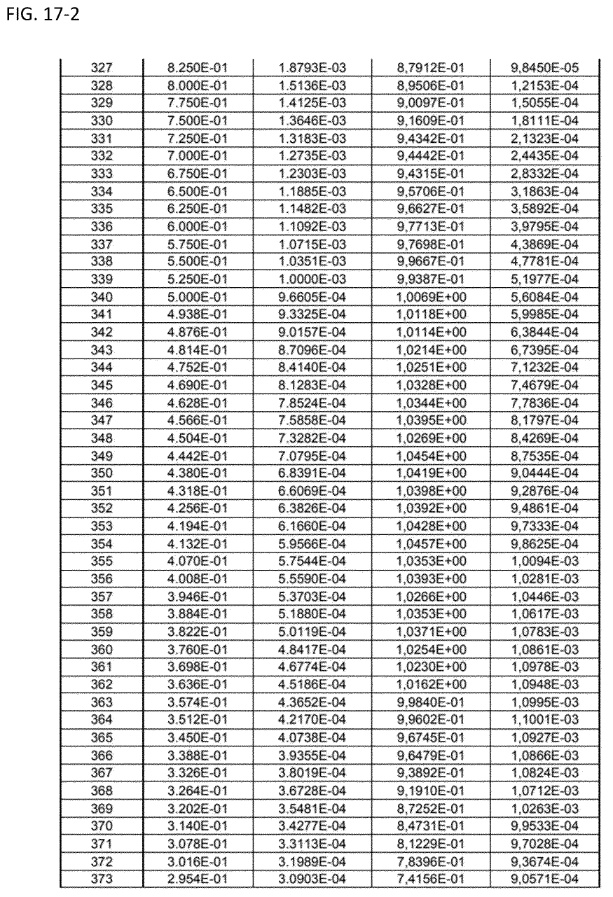

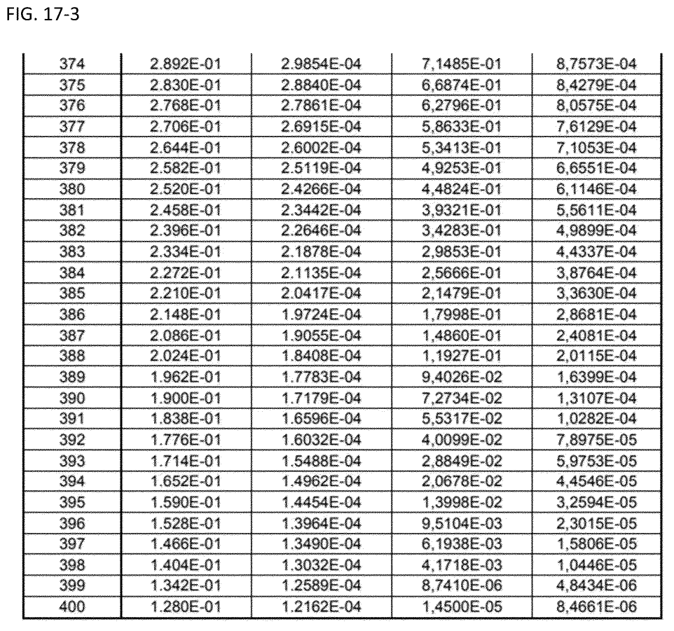

The SPF determined for each wavelength is determined in the range of 290to 320 nm, and the values are integrated. Here, CF represents a correction factor (=10), EE represents an erythemal effect spectrum, I represents a solar intensity spectrum, and Abs represents an absorbance of a sunscreen product. CF, EE, and I are constants, as for EE, values for each wavelength are given as Erythema action spectrum in the table of APPENDIX I of Non Patent Literature 4 shown in FIG. 17, and as for I, numerical values for each wavelength are given as UV-SSR source W.m₋₂nm₋₁ in the same table. Thus, these values were used. When the SPF values were calculated using the formula 1, a coefficient of determination much larger than that obtained from the ISO standard calculation formula was obtained. Furthermore, since the results obtained by the formula 1 were more consistent with the values measured using humans, this formula 1 was used in the present invention (while the coefficient of determination in the ISO standard was 0.5336, the coefficient of determination in the formula 1 was 0.6792).

In addition, an UVA for each wavelength is determined using the following formula: UVA=CF×ΣEE(λ)×I(λ)×Abs(λ) (Formula 2)

The UVA determined for each wavelength is determined in the range of 320to 400 nm, and the values determined at each wavelength are integrated.

Here, CF, EE, and I represent the same as those in the above (formula 1), EE represents an erythemal effect spectrum, I represents a solar intensity spectrum, and Abs represents an absorbance of a sunscreen product. They are similarly given in the table of APPENDIX I of Non Patent Literature 4 shown in FIG. 17. When the UVA was determined using the formula 2, a coefficient of determination much larger than that obtained from the ISO standard calculation formula was obtained (while the coefficient of determination in the ISO standard was 0.5767, the coefficient of determination in the formula 2 was 0.7900). Accordingly, in the present invention, also for UVA-PF, values obtained by using this calculation formula and changing the wavelength range to 320 to 400 nm were used.

The in vitro SPF value and the in vitro UVA-PF value obtained above cannot be compared with the conventional in vivo SPF value and in vivo UVA-PF value, respectively, as they are. To make a comparison, relational expressions showing the correlations are necessary. Expressions (relational expression between in vivo SPF value and in vitro SPF value and relational expression between in vivo UVA-PF value and in vitro UVA-PF value) obtained from the measurement results (ratio of in vitro SPF value and in vivo SPF value and ratio of in vitro UVA-PF value and in vivo UVA-PF value) of more than 200 commercially available sunscreen products from around the world are the following relational expressions, respectively; therefore, an in vivo SPF equivalent value and an in vivo UVA-PF equivalent value are determined using the relational expressions.

Relational expression between in vivo SPF value and in vitro SPF value: in vivo SPF equivalent value=in vitro SPF value/0.101 (Formula 3)

Relational expression between in vivo UVA-PF value and in vitro UVA-PF value: in vivo UVA-PF equivalent value=in vitro UVA-PF value/2.13 (Formula 4)

It should be noted that in the measurement results of more than 200 commercially available sunscreen products from around the world, a comparison was made using, as a sunlight spectrum, both the sunlight spectrum specified by the American Association of Textile Chemists and Colorists (AATCC) and the UV-SSR specified by ISO. According to the results, although there was not much difference in the results of UVA-PF, the coefficient by AATCC showed a slightly higher value. It is considered that using either one does not substantially cause problems. If calculation is performed using the light source of UV-SSR specified in the ISO method, a relational expression UVA-PF: in vivo UVA-PF equivalent value=in vitro UVA-PF value/3.6680 can be used.

Here, the methods for determining the expressions (relational expression between In vivo SPF value and In vitro SPF value and relational expression between In vivo UVA-PF value and In vitro UVA-PF value) obtained from the measurement results (ratio of in vitro SPF value and in vivo SPF value and ratio of in vitro UVA-PF value and in vivo UVA-PF value) of more than 200 commercially available sunscreen products from around the world will be described. These relational expressions are determined by statistically processing relationships among the SPF values and the UVA-PF values determined in the steps A to D described above and UVA-PF values indicated in the products. Currently, for SPF, in vivo values all measured using humans are internationally used. For UVA-PF, some manufacturers indicate actual numerical values on the packages, while other manufacturers indicate the PA classification, and in both cases, these are in vivo values measured using humans. When a value of UVA-PF is indicated, the value can be used as it is. When the PA classification is indicated, the range of its in vivo UVA-PF value is specified, and thus, in the present invention, as the in vivo UVA-PF value corresponding to the PA classification, a value in the middle of the range was caused to correspond to the UVA-PF value of the product. Specifically, in the case of PA+, the in vivo UVA-PF value was set to 3; in the case of PA++, the value was set to 6; in the case of PA+++, the value was set to 12; and in the case of PA++++, the value was set to 24. The in vitro SPF values of all the products were determined by the method according to the present invention, the numerals were plotted on the vertical axis, and the in vivo SPF values indicated on the packages were plotted on the horizontal axis. A straight-line approximation passing through the origin was performed to determine the approximate expression and the coefficient of determination. The relational expression between the in vivo SPF value and the in vitro SPF value of the formula 3 above was determined on the basis of this method. Similarly, the in vitro UVA-PF values of all the products were determined, the numerals were plotted on the vertical axis, and the in vivo UVA-PF values indicated on the packages were plotted on the horizontal axis. A straight-line approximation passing through the origin was performed to determine the approximate expression and the coefficient of determination. Lastly, the relational expression between the in vivo UVA-PF value and the in vitro UVA-PF value of the formula 4 above was determined.

With the methods described above, for typical emulsions, lotions, and spray products, including makeup cosmetics such as liquid foundations, it is possible to perform preparation and measurement of the absorbance of a reference film-thickness sample with a film thickness of 100 μm using an assembled cell.

Furthermore, the in vivo SPF equivalent value and the in vivo UVA-PF equivalent value can be determined by selecting the substrate with the maximum SPF value, and performing calculations by the formula (1) to the formula (4) above.

Next, specific procedures for measuring a powder cosmetic, such as a powder foundation, and a stick-like cosmetic, which are not fluids, will be described. The subsequent method for determining the in vivo SPF equivalent value and the in vivo UVA-PF equivalent value is the same as that for the above fluid cosmetics.

[B. Step of determining absorbance of cosmetic at reference thickness using assembled cell, and determining SPF value and UVA-PF value by formulas below (powder cosmetics)]

### Filling Assembled Cell With Sample

A glass plate or a ceramic plate is placed on a balance, and a powdered powder cosmetic is placed thereon in a donut shape. The glass plate or the ceramic plate is preferably a plate having a size of approximately 12 cm square and a smooth surface because such a plate is lightweight and makes the operations easier. Scattered powder is cleanly removed in advance using a brush. The weight of the powder cosmetic necessary for per substrate is approximately 1.5 g, and the weight is accurately measured and recorded. About 1.5 g of a non-volatile oil that does not have absorption in the UV region is added dropwise in a hole portion of the donut shape, and the weight is accurately measured and recorded. The non-volatile oil that does not have absorption in the UV region is preferably a non-polar oil or ester oil, which is easily mixed with powder cosmetics, in particular, squalene, which is internationally available and has a stable quality. The standard of non-volatility refers to having little or no volatility at normal temperature and pressure, and a non-volatile substance refers to a substance that changes in weight by 0.1% or less for about 10 minutes. The viscosity of the non-volatile oil used in the present invention is not particularly limited, but a non-volatile oil having a viscosity of, for example, 6 to 1,000 cs is easy to handle. An even balance capable of measuring 1 mg is preferably used as the balance. After weighing, mixing is sufficiently performed on the glass plate or the ceramic plate using a spatula for painting until lumps do not remain and a homogeneous paste-like substance is provided. In addition, it is important to mix little by little without mixing the whole at the same time. A powder cosmetic that has not been sufficiently mixed may adhere to the back surface of the spatula, and therefore, it is necessary to check this at the end. Once the mixed paste is completed, the entire amount of the mixed paste is poured onto a substrate, and the coating steps 1 to 3 described above are sequentially performed. On a surface of the applicator used in the coating step 3, the height of irregularities on the surface of a portion that comes in contact with the cosmetic is 1.0 μm or less. Subsequently, the drying step is omitted, and the measurement step with a spectrophotometer is performed.

The same applies to solid cosmetics that are not in the powder form.

With regard to the reference film-thickness sample, a mixed paste is prepared as in the case of a liquid cosmetic described above except that the amount of powder cosmetic is about 1 g, and the amount of non-volatile oil that does not have absorption in the UV region is about 1 g. Subsequently, as in the case of a liquid cosmetic, the paste is placed in a recess of a assembled cell and left to stand for several minutes, a flat plate of the assembled cell is then placed from above and fixed by applying a pressure, the short side of the assembled cell is held with the fingers, and the paste protruded around peripheral portions is wiped off. Force is slowly applied from one long side of the flat plate of the assembled cell to remove air bubbles as much as possible. Here, the biggest cause of variations in measured values in the preparation of samples of a powder cosmetic is the presence of air bubbles mixed during kneading. Accordingly, when the obtained sample is exposed to light, if bubbles are present, the step of measuring a reference film-thickness sample having a film thickness of 100 μm with a spectrophotometer is performed without measuring such a portion. In placing the paste in the recess of the assembled cell, placing a large excess amount of the paste, followed by pressing the flat plate easily removes air bubbles. Regarding the reference film-thickness sample, two or more sets of samples are prepared.

Next, for each substrate and each reference film-thickness sample, measured values for the powder cosmetic are obtained as in the step of measuring a reference film-thickness sample with a spectrophotometer in the case of a cosmetic other than solid cosmetics, except that an adjusted absorbance determined by dividing the obtained absorbance value by the value of “weight of powder cosmetic/(weight of non-volatile oil+weight of powder cosmetic)” is used as the absorbance of the sample. The in vivo SPF equivalent value and the in vivo UVA-PF equivalent value are then determined.

[B. Step of determining absorbance of cosmetic at reference thickness using assembled cell, and determining SPF value and UVA-PF value by formulas below (stick-like cosmetics)]

### Filling Assembled Cell With Sample

Next, procedures for measuring a stick-like cosmetic such as a lipstick or a stick-like sunscreen will be described. For a stick-like cosmetic, preferably, the measurement of a substrate is first performed, and the measurement of a reference film-thickness sample is then performed. This is because a large number of cosmetics that do not have absorption or scattering of light at a wavelength of 400 nm are present, and therefore, the measurement wavelength used for measuring the reference film-thickness sample needs to be determined from the measurement results of the substrate. A glass plate or a ceramic plate is placed on a balance, about 0.6 g of a stick-like cosmetic is rubbed against the plate to have a square frame shape using a spatula, and the amount of cosmetic is accurately measured and recorded. Subsequently, about 2.4 g of a non-volatile oil that does not have absorption in the UV region is added dropwise to the center of the square frame shape, and the weight is similarly measured and recorded. The cosmetic and the oil are mixed little by little using a spatula for painting. Once the whole is mixed, the mixed paste is transferred to a container such as a disposable aluminum cup for food and heated at 60° C. for 15 minutes using a hot plate. At this time, a cosmetic that has not been sufficiently mixed may adhere to the back surface of the spatula, and therefore, it is necessary to check this. If phase separation is observed after heating, mixing is sufficiently performed while the mixed paste is still warm. The entire amount of the mixed paste is poured onto the substrate, and the coating steps 1 to 3 described above are sequentially performed. On a surface of the applicator used in the coating step 3, the height of irregularities on the surface of a portion that comes in contact with the cosmetic is 1.0 μm or less. Subsequently, the drying step is omitted, and the measurement step with a spectrophotometer is performed.

With regard to the reference film-thickness sample, a mixed paste is prepared as in the case of preparation of the reference film-thickness sample of the powder cosmetic described above except that the amount of stick-like cosmetic applied is about 0.3 g, and the amount of non-volatile oil that does not have absorption in the UV region is about 1.2 g. Two or more sets of reference film-thickness samples are prepared as in the case of the powder cosmetic.

Next, for each substrate and each reference film-thickness sample, measured values of the stick-like cosmetic with a film thickness of 100 μm are obtained as in the method for preparing a reference film-thickness sample of the powder cosmetic, except that an adjusted absorbance determined by dividing the obtained absorbance value by the value of “weight of stick-like cosmetic/(weight of non-volatile oil +weight of stick-like cosmetic)” is used as the absorbance of the sample. Also in this step, the height of irregularities is 1.0 μm or less.

Here, in the present invention, an extremely sensitive measuring device including a main body having a measurement sensitivity reaching absorbance 8 is used in the measurement step with a spectrophotometer; however, in the cosmetic industries, a measuring device, a so-called SPF analyzer has hitherto been used. There are two typical models: one has a measurement sensitivity of absorbance of the order of 2, and the other has a measurement sensitivity of absorbance of the order of 3. On the other hand, there are measurement examples with an absorbance of 8 as described above. It is considered that, although there are differences depending on products, for products having an SPF value of 15 or less, the method according to the present invention can be performed without problems with sensitivity even using the existing two models. In the case of products having higher SPF values, some measured values are obtained, but they should be considered to include large error factors. As reported in WCOS 2022 above, we have confirmed that when the absorbance exceeds 2, the absorbance is indicated very differently depending on measuring instruments. Therefore, the objectivity of the measured values cannot be guaranteed unless the step is performed while sensitivity problems of the measuring instruments are properly recognized.

A problem with smoothness of a substrate will also be described here. In the cosmetic industries, the development has progressed considering that since the human skin has a texture and irregularities, a substrate for measurement also needs to have irregularities. On the other hand, a feature of the present invention lies in that the relationships between measured values obtained by the in vivo SPF measurement method and the in vivo UVA-PF measurement method and the in vitro SPF and UVA-PF values obtained by the method according to the present invention (the in vivo SPF equivalent value calculation formula and the in vivo UVA-PF equivalent value calculation formula) are determined, and the in vivo SPF and UVA-PF equivalent values are determined without using the in vitro SPF and UVA-PF values as they are. In the in vivo methods, the measurement is performed by firmly pressing an UV irradiation probe against the back of the human. https://solarlight.com/product/model-601-multiport-spf-testing-6-output-solar-simulator/shows a catalog of an UV irradiation device that is most commonly used for commissioned measurements, and describes the use of a series of six irradiation probes. A UV irradiation part of the probes is cylindrical and has a structure in which UV rays guided by an optical fiber is applied from the center. When the 8 mm cylinder is firmly pressed against the human skin, the skin is stretched to the maximum extent and flattened. In the present invention, since the relationships with the measurement results obtained in this flatted state are determined, the measurement substrates used are also smooth substrates. A plate having irregularities is suitable for measuring the effects of UV rays to which consumers are exposed in real life, rather than the in vivo measurement methods described above, and presumably, it is essentially difficult to compare with the existing in vivo measurement methods.

### EXAMPLES

Hereinafter, the present invention will be described in more detail with reference to Examples, but the present invention is not limited to these Examples.

[Reason why surface of applicator used in coating step 3 that comes in contact with cosmetic should be formed of material layer having oil adhesion prevention property]

Confirmation test of change in coating film in the case where material layer having oil adhesion prevention property is provided or not provided on coating portion of applicator

### Measurement Conditions

An infrared imaging microscope (iN10 MX infrared imaging system all-in-one FT-IR microspectrometer, manufactured by Thermo Fisher Scientific) was used, the measurement interval was 100 μm×100 μm, the measurement wavenumber was 2,852 cm₋₁, a transmission measurement using liquid nitrogen was performed, the integration was performed 16 times for each measurement point, and a quartz plate made of synthetic quartz was used as a reference. As for a measurement range, a range of 70 mm was measured in a direction in which an applicator traveled. This device originally provides mapping analysis results in color, but in the present patent, white areas indicate higher concentration (lower transmittance).

Measurement sample: Milky lotion composed of water, zinc oxide, ethanol, ethylhexyl methoxycinnamate, isocetyl myristate, glycerin, propylene glycol, bisethylhexyloxyphenol methoxyphenyl triazine, polyhydroxystearic acid, phenoxy ethanol, methicone, xanthan gum, fragrance, EDTA-2Na, biosaccharide gum-1, pigment, (Na acrylate/Na acryloyldimethyltaurate) copolymer, isohexadecane, polysorbate 80, and sorbitan oleate (a preparation obtained by selecting and adjusting ingredients from the infrared spectrum of each ingredient so that the behavior of an UV absorbent (oil layer) becomes clear in infrared observation)

Applicator: A cylindrical applicator having a surface made of stainless steel and cylindrical applicators in which various material layers were fixed on the surfaces thereof were used.

Coating conditions: Coating was performed at a speed of 5 mm/s using a precision coating device.

Substrate used for coating: A surface of a quartz plate made of synthetic quartz with a size of 10×10 cm was treated for 90 seconds using a corona-discharge device (BD-20AC Laboratory Corona Treater, manufactured by Electro-Technic Products, Inc.). The treatment was performed using a robot so that the entire surface was uniform.

Measurement of film thickness: The measurement was performed using a rotary film thickness gauge.

### Test Results

FIG. 10 shows the results of observation of a coating film applied using a stainless-steel cylindrical applicator, obtained using the infrared imaging microscope under the above-described measurement conditions described. The area on the right side of −15000 is an area of the coating film that is usually used for an evaluation test of UV protection performance. It was confirmed that the film thickness in this area was uniform with the rotary film thickness gauge. In FIG. 10, areas that appear white are areas where the concentration of the UV absorbent is relatively high. This shows that even when the coating film appears to have a uniform thickness in appearance, the concentration of the UV absorbent is not uniform.

FIG. 11 shows the results of observation of a coating film applied using an applicator that is the same as the cylindrical applicator except that a hydrophilized polyethylene terephthalate film was fixed to the surface that came in contact with the cosmetic, obtained using the infrared imaging microscope. Areas having a high concentration of the UV absorbent were not particularly observed, showing that stable coating was achieved.

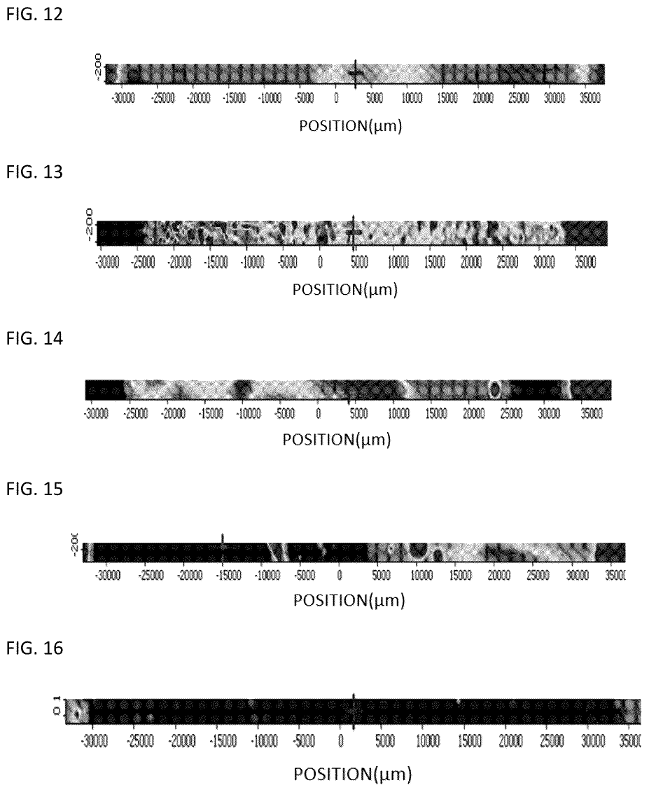

Furthermore, FIG. 12 shows the results of observation in the case of using a polyethylene terephthalate film that was not hydrophilized, obtained using the infrared imaging microscope. It is found that when hydrophilization was not performed, shading of the concentration of the UV absorbent occurred.

FIG. 13 shows the results of observation of a coating film applied by using an applicator to which a polyimide tape was fixed, obtained using the infrared imaging microscope. It is found that shading of the concentration of the UV absorbent occurred significantly.

FIG. 14 shows the results of observation of a coating film applied by using an applicator to which a polyvinyl chloride tape was fixed, obtained using the infrared imaging microscope. It is found that shading of the concentration of the UV absorbent occurred significantly.

FIG. 15 shows the results of observation of a coating film applied by using an applicator to which a silicone rubber was fixed, obtained using the infrared imaging microscope. It is found that shading of the concentration of the UV absorbent occurred significantly.

FIG. 16 shows the results of observation of a coating film applied by using an applicator to which a PEN film was fixed, obtained using the infrared imaging microscope. Areas having a high concentration of the UV absorbent were not particularly observed, showing that stable coating was achieved.

Various materials were screened in this manner on the basis of the presence or absence of a high concentration area, and PEN, hydrophilized polyethylene terephthalate, etc. were found to be excellent in terms of uniformity of coating films.

### Example 1

A description will be given of an example of a series of operations for obtaining, using an emulsion cosmetic composed of ingredients shown in Table 2, an in vivo SPF equivalent value and an in vivo UVA-PF equivalent value of the product. Note that when the UV protection performance of the milky lotion described in Table 2 was measured using humans, the SPF value was 56, and the UVA-PF was 19.9.

The spectrophotometer used was an UV visible spectrophotometer LAMBDA 850+ (measurement sensitivity, absorbance 8) manufactured by PerkinElmer and including a 150 mm integrating sphere therein, and the assembled cell used was T-20-UV-0.1 manufactured by Tosoh Corporation.

The drying time of each substrate is one hour. As the coating step 1, the emulsion cosmetic was leveled using a 500 μm stainless steel four-sided applicator. Subsequently, in the coating step 2, a sponge-like urethane (15 mm in width, 10 mm in height, and 35 mm in length) was used as a coating tool attached to the tip of a rotating device, and spreading was performed for 12 seconds at a rate of rotary coating of 260 rpm. PEN was used as a covering material of a cylindrical applicator (in which a cross section of an area that came in contact with the cosmetic during application was a curved surface reflecting a circle with a diameter of 12 mm) used in the coating step 3, and the gap with each substrate was 25 μm. Three types of substrates used were an acrylic-based polyisocyanate-treated plate (contact angle after one week after application of acrylic-based polyisocyanate: ) 80°, a hydroxyalkyl cellulose-treated plate (contact angle after one week after application of hydroxyalkyl cellulose: 51° to) 52°, and an inulin-coated plate (inulin-coated quartz plate) (contact angle after one week after application of inulin: 23° to) 26°. Note that these contact angles are contact angles of pure water at 25° C.

TABLE 2
Names of ingredients

Water
Ethylhexyl methoxycinnamate
BG
Diethylamino hydroxybenzoyl hexyl benzoate
Ethanol
Ethylhexyl triazone
Bis-ethylhexyloxyphenol methoxyphenyl triazine
Dimethicone
Diisopropyl adipate
Methyl methacrylate crosspolymer
(HDI/trimethylol hexyllactone) crosspolymer
PEG-20 glyceryl triisostearate
Ethylhexylglycerin
Glyceryl caprylate
Sorbitan sesquiisostearate
Fragrance
(Acrylates/beheneth-25 methacrylate) copolymer
Potassium hydroxide
PPG-8-ceteth-20
Tocopherol
EDTA-2Na
Citrus junos fruit extract
Biosaccharide gum-1
Phenoxyethanol

As a plurality of types of UV transmission ratio evaluation substrates, one lipophilic moisture-curable acrylic-based polyisocyanate (simply expressed as polyisocyanate in tables)-treated plate, one hydroxyalkyl cellulose-coated plate, and one inulin-coated plate were prepared. As the coating step 1, the milky lotion described in Table 2 was applied thereto using a stainless-steel applicator with a gap of 500 μm. Subsequently, as the coating step 2, the milky lotion was immediately spread at 260 rpm for 12 seconds using a rotating device to which a urethane sponge was fixed. Subsequently, as the coating step 3, a coating film was immediately formed using the PEN-coated cylindrical applicator described above. The plates were stored in a cool, dark place for one hour, and the absorbance was measured at three points for each plate using a spectrophotometer.

Two sets of assembled cells with a depth of 100 μm that were separately prepared were each filled with the milky lotion described in Table 2. After filling, the assembled cells were allowed to stand for 15 minutes on a precision hot plate heated to 60° C. and then left to cool to room temperature. The absorbance at 400 nm was measured at two points for each assembled cell using a spectrophotometer to obtain measured values at a total of four points. Actual measured values of 1.174941, 1.159418, 1.277993, and 1.155809 were obtained as the values of absorbance, the average absorbance was 1.19204, the standard deviation was 0.0579, and standard deviation/average absorbance=4.9%. Since the standard deviation/average absorbance was 4.9%, which was 20% or less, the measurement was performed at four points.

Since the average absorbance of 1.19204 is a value at 100 μm, for the value per 20 μm, multiplying this value by 0.2 yields 0.238408. Using this value as a reference, the spectrum corresponding to a film thickness of 20 μm was determined by proportional calculation from the values of absorbance at 400 nm measured at the nine points on the plates.

Spectral data equivalent to 20 μm of the nine measurement points was obtained as described above. This data was used to determine, as Example 1, the SPF value and the UVA-PF value determined in accordance with the formula (1) and the formula (2), respectively, and, as Comparative Example 1, the SPF value and the UVA-PF value based on the ISO standard methods determined in accordance with Non Patent Literature 4. Note that, in the calculation formulas of the formulas (1) and (2), values determined by using, as a sunlight spectrum, data of sunlight spectrum specified by AATCC are shown. Tables 3 and 4 show the results.

TABLE 3

| | SPF | |
|---|---|---|
| UV transmission ratio | Value determined | Value determined |
| evaluation substrate | by formula (1) | by ISO standard |
| Lipophilic polyisocyanate- | 4.682821079 | 146.1796068 |
| treated plate | | |
| Hydroxyalkyl cellulose- | 6.83223345 | 296.0188865 |
| coated plate | | |
| Inulin-coated plate | 6.453689161 | 265.303419 |

TABLE 4

| | UVA-PF | |
|---|---|---|
| UV transmission ratio | Value determined | Value determined |
| evaluation substrate | by formula (2) | by ISO standard |
| Lipophilic polyisocyanate- | 34.23424469 | 21.12210293 |
| treated plate | | |
| Hydroxyalkyl cellulose- | 45.86799382 | 26.60630364 |
| coated plate | | |
| Inulin-coated plate | 43.25500714 | 24.56087138 |

Referring to Table 3, it is found that the plate exhibiting the highest SPF value determined by the formula 1 is the hydroxyalkyl cellulose-coated plate, and the in vitro SPF value of this product is about 6.8. The in vitro UVA-PF value similarly determined by the formula 2 is about 45.9 measured using the same plate. The in vivo SPF equivalent value determined from the formula 3 using this in vitro SPF value is 67.7, and similarly, the in vivo UVA-PF equivalent value determined from the formula 4 using this in vitro UVA-PF value is 21.6. In the case of the ISO methods, the values should be used as they are; therefore, the in vitro SPF value is 296, and the in vitro UVA-PF value is 26.6. Thus, for both the values, there was a large difference. On the other hand, as described above, the in vivo measured values of this product are an SPF of 56 and an UVA-PF of 19.9, showing that the measurement methods according to the present invention show values that are extremely close to those measured by the in vivo methods compared with the ISO methods, which are Comparative Examples.

In addition, even when a film formed of, instead of PEN above, hydrophilized polyester, hydrophilized polyethylene terephthalate, polyvinylidene fluoride, tetrafluoroethylene, fluorinated ethylene propylene polymer, perfluoroalkoxy polymer, ethylene tetrafluoroethylene copolymer, ethylene chlorotrifluoroethylene copolymer, polychlorotrifluoroethylene, and polyvinyl fluoride were adopted, respectively, a thin layer composed of the milky lotion shown in Table 2 and having the same properties as the original properties of this milky lotion could be formed on a hydroxyalkyl cellulose-coated plate, as in the case of using PEN.

### Example 2

Measurements were performed using a commercially available powder cosmetic (face powder). It should be noted that the package of the commercially available product indicated an SPF value of 32 and a PA classification of +++ (equivalent to 8 to 16 in terms of UVA-PF) (in vivo UVA-PF value corresponding to the PA classification: 12) and had the following ingredient labeling.

Talc, Perlite, Titanium Dioxide, Ethylhexyl Methoxycinnamate, Dimethicone, Aluminum Hydroxide, Stearic Acid, Silica, Methicone, Caprylyl Glycol, Ethylhexylglycerin, BHT, Cetyl PEG/PPG-10/1 Dimethicone, Tocopherol, Pentaerythrityl Tetra-di-t-butyl Hydroxyhydrocinnamate, (+/−) Titanium Dioxide, Mica, Iron Oxides

One lipophilic moisture-curable acrylic-based polyisocyanate-treated plate, one hydroxyalkyl cellulose-coated plate, and one inulin-coated plate, which were the same as those described above, were prepared. On a 12 cm-square surface-hardened glass plate, the powder cosmetic was finely scraped with a spatula and placed in a donut shape. The weight of the powder cosmetic was 1.500 g. To the powder cosmetic, 1.500 g of squalene was added and sufficiently mixed with a spatula for painting, and the resulting mixed paste was spread on a substrate. This operation was repeated three times to prepare samples formed of each of the substrates having the mixed paste spread on a surface thereof. Subsequently, as the coating step 1, the mixed paste was similarly leveled using a 500 μm stainless steel four-sided applicator as in Example 1. Subsequently, as the coating step 2, the mixed paste was immediately spread at 260 rpm for 12 seconds using the same rotating device to which a urethane sponge was fixed as that used in Example 1. Subsequently, as the coating step 3, a coating film was immediately formed using the same PEN-coated cylindrical applicator as that used in Example 1. The absorbance was measured at three points for each plate using a spectrophotometer.

Three sets of assembled cells having a recess with a depth of 100 μm were each filled with the mixed paste prepared in the same manner as above and having a value of powder cosmetic/(powder cosmetic+squalene) of 0.615. The absorbance at 400 nm was measured at two points for each assembled cell using a spectrophotometer to obtain measured values at a total of six points. It should be noted that, although there is no problem even with four points, data for six points are shown here in order to show how much variation occurs when the powder cosmetic is actually measured by this method. Actual measured values of 4.779588, 4.715465, 4.95402, 4.692718, 5.403312, and 4.901608 were obtained as the values of absorbance, the average absorbance was 4.907785167, the standard deviation was 0.263589873, and standard deviation/average absorbance=5.4%. This average absorbance is measured using the diluted powder cosmetic; therefore, assuming that the powder cosmetic is not diluted, dividing the value of the average absorbance by the above mixing ratio yields 7.980.

Tables 5 and 6 show the results obtained by correcting using this value, with respect to the film thickness, the values of absorbance determined in advance at the total of nine points.

TABLE 5

| | SPF | |
|---|---|---|
| UV transmission ratio | Value determined | Value determined |
| evaluation substrate | by formula (1) | by ISO standard |
| Lipophilic polyisocyanate- | 5.355232258 | 100.6848401 |
| treated plate | | |
| Hydroxyalkyl cellulose- | 4.428813801 | 67.02088636 |
| coated plate | | |
| Inulin-coated plate | 4.499381589 | 94.85938376 |

TABLE 6

| | UVA-PF | |
|---|---|---|
| UV transmission ratio | Value determined | Value determined |
| evaluation substrate | by formula (2) | by ISO standard |
| Lipophilic polyisocyanate- | 23.4704833 | 13.41072424 |
| treated plate | | |
| Hydroxyalkyl cellulose- | 22.00354695 | 12.18088692 |
| coated plate | | |
| Inulin-coated plate | 25.16421589 | 15.51185452 |

Referring to Tables 5 and 6, the plate exhibiting the highest SPF value determined by the formula 1 was the lipophilic plate. The in vitro SPF value of this product is 5.4, and the in vitro UVA-PF value similarly determined by the formula 2 is 23.5 measured using the same plate. The in vivo SPF equivalent value determined from the formula 3 using this in vitro SPF value is 53.3, and similarly, the in vivo UVA-PF equivalent value determined from the formula 4 using this in vitro UVA-PF value is 11.0. In the case of the ISO methods, the values should be used as they are; therefore, the in vitro SPF value is 100.6, and the in vitro UVA-PF value is 13.4. With regard to the in vitro UVA-PF value, both the values were within the same range as the value indicated on the product; however, with regard to the SPF value, a larger difference occurred with the ISO method.

### Example 3

Measurements were performed using a commercially available stick-type sunscreen product. It should be noted that the package of the commercially available product indicated an SPF value of 50+ and a PA classification of ++++ (equivalent to 16 to 32 in terms of UVA-PF) (in vivo UVA-PF value corresponding to the PA classification: 24) and had the following ingredient labeling.

Triethylhexanoin, Isononyl Isononanoate, Polymethylsilsesquioxane, Dimethicone, Nylon-12, Ethylhexyl Methoxycinnamate, Polyethylene, Synthetic Wax, Trimethylpentanediol/Adipic Acid/Glycerin Crosspolymer, Butyl Methoxydibenzoylmethane, Dimethicone/Vinyl Dimethicone Crosspolymer, Sucrose Polystearate, Polysilicone-15, Menthol, Alumina, Tocopherol, Water, Butylene Glycol, Saxifraga sarmentosa Extract, Geranium robertianum Extract, Vaccinium myrtillus Leaf Extract, Cynara scolymus (Artichoke) Leaf Extract, BHT, Fragrance

One lipophilic moisture-curable acrylic-based polyisocyanate-treated plate, one hydroxyalkyl cellulose-coated plate, and one inulin-coated plate, which were the same as those described above, were prepared. On a 12 cm-square surface-hardened glass plate, the cosmetic is rubbed against the plate to have a square frame shape using a spatula for paintings. The weight of the cosmetic was 0.600 g. To the center of the square frame shape, 2.400 g of squalene was added dropwise and sufficiently mixed with a spatula. The resulting mixed paste was put in a disposable aluminum cup for food, heated at 60° C. for 15 minutes, and then poured onto the plate. This operation was repeated three times to prepare samples formed of each of the substrates having the mixed paste spread on a surface thereof. Subsequently, as the coating step 1, the mixed paste was similarly leveled using a 500 μm stainless steel four-sided applicator as in Example 1. Subsequently, as the coating step 2, the mixed paste was immediately spread as in Example 1 at 260 rpm for 12 seconds using a rotating device to which a urethane sponge was fixed. Subsequently, as the coating step 3, a coating film was formed using the PEN-coated cylindrical applicator as in Example 1. The absorbance was measured at three points for each plate using a spectrophotometer.

Two sets of assembled cells with a depth of 100 μm were each filled with the mixed paste prepared in the same manner as above and having a value of stick-like cosmetic/(stick-like cosmetic+squalene) of 0.208. It should be noted that the above measurement revealed that this cosmetic had almost no absorption at a wavelength of 400 nm but had sufficient adsorption at a wavelength of 360 nm; therefore, the measurement wavelength was changed to 360 nm. Values of 3.883449, 3.774979, 3.804809, and 3.645621 at four points were obtained as actual measured values of the absorbance, the average absorbance was 3.777215, the standard deviation was 0.098943, and standard deviation/average absorbance=2.6%. This average absorbance is measured using the diluted cosmetic; therefore, assuming that the cosmetic is not diluted, dividing the value of the average absorbance by the above mixing ratio yields 18.2. Tables 7 and 8 show the results obtained by correcting using this value, with respect to the film thickness, the values of absorbance determined in advance at the total of nine points.

TABLE 7

| | SPF | |
|---|---|---|
| UV transmission ratio | Value determined | Value determined |
| evaluation substrate | by formula (1) | by ISO standard |
| Lipophilic polyisocyanate- | 2.854731581 | 16.95899725 |
| treated plate | | |
| Hydroxyalkyl cellulose- | 3.165587076 | 19.47276036 |
| coated plate | | |
| Inulin-coated plate | 3.031010476 | 18.80183919 |

TABLE 8

| | UVA-PF | |
|---|---|---|
| UV transmission ratio | Value determined | Value determined |
| evaluation substrate | by formula (2) | by ISO standard |
| Lipophilic polyisocyanate- | 11.97693823 | 3.506189836 |
| treated plate | | |
| Hydroxyalkyl cellulose- | 12.02769372 | 3.461358974 |
| coated plate | | |
| Inulin-coated plate | 12.30134862 | 3.572286152 |

Referring to Table 7, the plate exhibiting the highest SPF value determined by the formula 1 was the hydroxyalkyl cellulose-coated plate. The in vitro SPF value of this product is about 3.2, and similarly, the in vitro UVA-PF value is about 12.0 measured using the same plate. The in vivo SPF equivalent value determined from the formula 3 using this in vitro SPF value is 31.8, and similarly, the in vivo UVA-PF equivalent value determined from the formula 4 using this in vitro UVA-PF value is 5.6. In the case of the ISO methods, the values should be used as they are; therefore, the in vitro SPF value is 19.5, and the in vitro UVA-PF value is 3.5. Compared to the values indicated on the product, according to the formula 3 and the formula 4, the SPF value was a slightly smaller value and the UVA-PF values matched, while both were considerably smaller values according to the ISO standard methods.

### Comparative Example 1 and Example 4

Measurements were performed using a commercially available pressure can sunscreen spray. It should be noted that the package of the commercially available product indicated an SPF value of 100 and had the following ingredient labeling.

avobenzone (3%), homosalate (10%), octisalate (5%), octocrylene (10%), oxybenzone (6%), alcohol denat., isobutane, VA/butyl maleate/isobornyl acrylate copolymer, caprylylglycol, cyclopentasiloxane, cyclohexasiloxane, fragrance, polyglyceryl-3 stearate/isostearate/dimer dilinoleate crosspolymer, lauryl PEG-8 dimethicone, phenylisopropyl dimethicone, ascorbyl palmitate, methyl dihydroabietate, tocopheryl acetate, mineral oil, panthenol, water, Aloe barbadensis leaf extract.

One lipophilic moisture-curable acrylic-based polyisocyanate-treated plate, one hydroxyalkyl cellulose-coated plate, and one inulin-coated plate, which were the same as those described above, were prepared. As a single coating step, the sunscreen was sprayed from above, and a stainless-steel four-sided applicator with a gap of 20 μm was used to form a coating film by traveling the applicator at a speed of 5 mm/s. Subsequently, an attempt was made to measure the film thickness with a rotary film thickness gauge, but the film thickness could not be measured because the cosmetic was transparent.

In view of the above, measurements were performed in accordance with Example 1. According to the results, the hydroxyalkyl cellulose-coated plate was selected, the in vitro SPF value was 4.8, and similarly, the in vitro UVA-PF value was 35.6 measured using the same plate. The in vivo SPF equivalent value determined from the formula 3 using this in vitro SPF value was 47.8, and similarly, the in vivo UVA-PF equivalent value determined from the formula 4 using this in vitro UVA-PF value was 16.7. The method for measuring a film thickness using an assembled cell used in the present invention is very suitable for cosmetics such as lotions with transparent appearance and cosmetics that provide coating films with many irregularities.

### Comparative Example 2 and Example 5

Measurements were performed using a commercially available sunscreen product. It should be noted that the package of the commercially available product indicated an SPF value of 8 and had the following ingredient labeling.

Water, Alcohol, Phenylbenzimidazole Sulfonic Acid, Triethanolamine, Camellia sinensis Leaf Extract, Rosmarinus officinalis (Rosemary) Leaf Extract, Coix lacryma-jobiMa-yuen Seed Extract, Aloe barbadensis Leaf Extract, Dipotassium Glycyrrhizate, PEG-12 Dimethicone, Dipropylene Glycol, PEG/PPG-30/10 Dimethicone, Dimethicone, Phenyl Trimethicone, Butylene Glycol, Potassium Hydroxide, Menthol, Fragrance

One lipophilic acrylic-based polyisocyanate-treated plate and one hydroxyalkyl cellulose-coated plate, which were the same as those described above, and one superhydrophilic plate subjected to a corona-discharge treatment were prepared. The sunscreen was applied from above, and as the coating step 1, coating of the cosmetic was performed as in Example 1 using a stainless-steel four-sided applicator with a gap of 500 μm. Subsequently, as the coating step 2, spreading was immediately performed as in Example 1 at 260 rpm for 12 seconds using a rotating device to which a urethane sponge was fixed. Subsequently, as the coating step 3, a coating film was immediately formed using a stainless-steel four-sided applicator with a gap of 20 μm by traveling the applicator at a speed of 5 mm/s, and the film thickness was then measured with a rotary film thickness gauge. The film thicknesses were 5, 2, and 1 μm in the order of the plates. The SPF values equivalent to a thickness of 20 μm determined by the ISO method were 9, 32, and 63, respectively. Regarding the treatment state of the superhydrophilic plate subjected to the corona-discharge treatment, most of the cosmetic adhered to the stainless-steel applicator, and the coating film was formed in which some of the ingredients were phase-separated. A similar state was generated also in the hydroxyalkyl cellulose-coated plate. The reason for this is presumably as follows. Since metal is lipophilic, if the sunscreen product happened to be a cosmetic having a high affinity with metal, even when an applicator with a narrow gap was caused to travel, the sunscreen product would not be appropriately divided up and down and most of the sunscreen product would be distributed to the metal side.

In view of the above, the test of this product was performed as in Example 1. As a result, such a problem did not occur in the PEN-coated cylindrical applicator, and uniform coating films could be formed, thus demonstrating the effect of a polyethylene naphthalate film. The test was also performed using a hydrophilized polyester film, a hydrophilized polyethylene terephthalate film, a polyvinylidene fluoride film, and a typical fluororesin film. As a result, coating films could be formed in each case, and the effectiveness of the above films was confirmed. In contrast, for the other film-like materials shown in Table 1, in each case, there was a problem with the uniformity of coating films, or, for example, a problem that the applicator did not travel properly occurred.

The above test results demonstrate that Examples of the present invention solve the problems of Comparative Examples and are excellent as measurement methods applicable to a wide range of cosmetics.

What is claimed:

1. A method for evaluating UV protection performance of a cosmetic, the method comprising a preparation step of preparing a measurement sample for evaluating UV protection performance of a target cosmetic, wherein the preparation step is a step including forming a uniform cosmetic application layer of the cosmetic on an UV-transmittance-measurement transparent substrate surface, by using a surface of an applicator having a layer made of a non-metal material constituting the surface that has an oil adhesion prevention property.

2. The method for evaluating UV protection performance of a cosmetic according to claim 1, wherein the material layer with the surface having the oil adhesion prevention property is a layer formed of one or more selected from the group consisting of a polyethylene naphthalate (PEN) film, a hydrophilized polyester film, a hydrophilized polyethylene terephthalate film, and a fluororesin film, which have the oil adhesion prevention property.

3. The method for evaluating UV protection performance of a cosmetic according to claim 1, comprising the following steps A to D:
A: the preparation step comprising a step of preparing a plurality of measurement samples of the target cosmetic for evaluating UV protection performance of the cosmetic, by forming a plurality of uniform cosmetic application layers on surfaces of a plurality of UV-transmittance-measurement transparent substrates having different contact angles, respectively, using the applicator including the layer with the surface having the oil adhesion prevention property;
B: a step of determining an absorbance of the cosmetic at a reference thickness using an assembled cell and a spectrophotometer to determine a thickness of each measurement sample by comparison, and determining an SPF (Sun Protection Factor) value and a UVA-PF (Protection grade of UVA) value of each measurement sample based on the determined thickness by the following formulas:
an SPF value obtained by performing integration for every 1 nm from 290 to 320 nm using a formula CF×ΣEE(λ)×I(λ)×Abs(λ) ,
a UVA-PF value obtained by performing integration for every 1 nm from 320 to 400 nm using a formula CF×ΣEE(λ)×I(λ)×Abs(λ) ,
where CF represents a correction factor (=10), EE represents an erythemal effect spectrum, I represents a solar intensity spectrum, and Abs represents an absorbance, of each measurement sample;
C: a step of selecting, on a basis of the SPF values obtained for the plurality of measurement samples, a measurement sample with a maximum SPF value, and defining the SPF value and the UVA-PF value of the selected measurement sample as an in vitro SPF value and an in vitro UVA-PF value, respectively, of the cosmetic;
D: a step of determining an in vivo SPF equivalent value of the cosmetic from a predetermined relational expression between an in vivo SPF value and the in vitro SPF value, and further determining an in vivo UVA-PF equivalent value of the cosmetic from a predetermined relational expression between an in vivo UVA-PF value and the in vitro UVA-PF value.

4. The method for evaluating UV protection performance of a cosmetic according to claim 3, wherein the plurality of UV-transmittance-measurement transparent substrates having different contact angles are the following three substrates: an UV-transmittance-measurement transparent substrate having, on a surface thereof, a layer formed by applying a polyisocyanate, an UV-transmittance-measurement transparent substrate having, on a surface thereof, a layer formed by applying inulin, and an UV-transmittance-measurement transparent substrate having, on a surface thereof, a layer formed by applying a hydroxyalkyl cellulose.

5. The method for evaluating UV protection performance of a cosmetic according to claim 3, wherein the predetermined relational expression between the in vivo SPF value and the in vitro SPF value and the predetermined relational expression between the in vivo UVA-PF value and the in vitro UVA-PF value are preliminarily determined by statistically processing relationships between (i) SPF values and UVA-PF values obtained by in vivo methods or in vivo UVA-PF values corresponding to a PA (Protection Grade of UV-A) classification, of property-known cosmetics, and (ii) SPF values and UVA-PF values of the cosmetics determined in accordance with the steps A to D.

6. The method for evaluating UV protection performance of a cosmetic according to claim 1, wherein the cosmetic is a powder cosmetic, a stick-like cosmetic, or a paste-like substance obtained by mixing a non-volatile oil with a solid cosmetic.
